(19) United States
(12) Patent Application Publication
(10) Pub. No.: US 2018/0300811 A1
(43) Pub. Date: Oct. 18, 2018

(54) METHOD AND SYSTEM OF EXCHANGING AND DERIVING ECONOMIC BENEFIT FROM EXCHANGING SECURITIES

(71) Applicant: Thermodynamic Design, LLC, Rockville, MD (US)

(72) Inventor: Jacob Wohlstadter, Potomac, MD (US)

(21) Appl. No.: 16/013,098

(22) Filed: Jun. 20, 2018

Related U.S. Application Data
(63) Continuation of application No. 15/143,816, filed on May 2, 2016.
Application No. 15/143,816 is a continuation of application No. 10/138,038, filed on May 3, 2002, now abandoned.
(60) Provisional application No. 60/288,645, filed on May 3, 2001.

(51) Int. Cl. G06Q 40/04; G06Q 20/10

(52) U.S. Cl. CPC G06Q 40/04; G06Q 20/102

(57) ABSTRACT

A method and system of conducting transactions in securities provides a measure of economic benefit to the issuing entity whenever a security issued by the entity is involved in a transaction. For example, an entity issuing stock may receive a measure of economic benefit whenever the stock is traded between third parties on a stock exchange. A computer system or computer program running on a computer system forming a computerized exchange may be provided to enable transactions in securities and to calculate a measure of economic benefit payable to the issuing entity for transactions involving securities issued by that entity. The measure of economic benefit may take the form of any benefit to the issuing entity or of detriment to one of the other parties or intermediaries involved in the transaction.

### RELATED APPLICATION DATA

This application is a continuation of co-pending U.S. patent application Ser. No. 15/143,816, filed May 2, 2016, entitled METHOD AND SYSTEM OF EXCHANGING AND DERIVING ECONOMIC BENEFIT FROM EXCHANGING SECURITIES, bearing Attorney Docket No. W0538.70005US01, which is a continuation of U.S. patent application Ser. No. 10/138,038, filed May 3, 2002, entitled METHOD AND SYSTEM OF EXCHANGING AND DERIVING ECONOMIC BENEFIT FROM EXCHANGING SECURITIES, bearing Attorney Docket No. W0538.70005US00, which claims the benefit under 35 U.S.C. § 119(e) of the filing date of U.S. Provisional Patent Application Ser. No. 60/288,645, filed May 3, 2001, entitled METHOD AND SYSTEM OF EXCHANGING AND DERIVING ECONOMIC BENEFIT FROM EXCHANGING SECURITIES, bearing Attorney Docket No. W0538.70004US00. The entirety of each of the documents listed above is incorporated herein by reference.

### FIELD OF THE INVENTION

The present invention relates to a method and apparatus for conducting transactions in securities (as defined below) and, more particularly, to a method and apparatus for conducting transactions in securities while transferring a measure of economic benefit associated with that transaction to the entity issuing the security.

### BACKGROUND OF THE INVENTION

The American investment system, and indeed much of the international investment system, is fundamentally derived from the ability of individuals and commercial organizations to buy and sell instruments representing financial interests in other commercial organizations or institutions (entities) such as businesses, mutual funds, etc. The underlying goal of participants in this investment system, for investors, is to buy the instrument at a low price, hold it for a period of time, sell the instrument at a higher price, and realize the difference between purchase price and sale price as profit. Of course, taxes, commissions, etc., may reduce the amount of profit for any one transaction. Likewise, not all instruments appreciate in value over time, and a subsequent sale of the instrument may result in a loss to the original purchaser. The inventions set forth herein relate to variations in this basic investment system.

The following definitions are set forth to clarify the meaning of particular terms that will be used throughout this specification and claims. Non-defined terms may be interpreted according to their use in context and their customary meaning to one of skill in the art, for example as defined in Section 3 of the Securities Exchange Act of 1934.

As used herein, the term “transaction” shall include a trade, sale, lease, transfer for value, gift, or other disposition of a security (defined below). The terms “sale” and “sell” each include any contract to sell or otherwise dispose of. Likewise, the terms “buy” and “purchase” each include any contract to buy, purchase, or otherwise acquire. Transactions may be directly consummated between participants or may be intermediated (discussed below).

Typical transactions may involve financial instruments referred to as securities. As used herein, the term “security” includes any note, stock, bond, debenture, or in general, any instrument commonly known as a “security.” In one embodiment, “security” includes an instrument of a governmental entity, such as a bond, that is also subject to taxation by that same governmental entity. In another embodiment, “security” specifically excludes an instrument of a governmental entity, such as a bond, that is also subject to taxation by that same governmental entity. For example, the term “security” may include: (a) a certificate of interest or participation in any profit-sharing agreement or in any oil, gas, or other mineral royalty or lease; (b) a collateral-trust certificate, preorganization certificate or subscription, transferable share, investment contract, voting-trust certificate, or certificate of deposit for a security; (c) a put, call, straddle, option, or privilege on any security, certificate of deposit, or group or index of securities or futures or derivatives; (d) a stock or similar security; or any security, convertible, with or without consideration, into such a security, or carrying any warrant or right to subscribe to or purchase such a security; and (e) a certificate of interest or participation in, temporary or interim certificate for, receipt for, or warrant or right to subscribe to or purchase, any of the foregoing. While this list is extensive, it is not intended to be exhaustive, and the term “security” therefore shall also be interpreted to include, in general, any instrument commonly known as a “security.” The term “security” thus encompasses numerous investment vehicles that may or may not be regulated by a governmental entity, and that may be publicly or privately tradeable.

Securities are generally issued by a corporation, partnership, limited liability company, limited liability partnership, trust, labor group, union, mutual fund, an individual or group of individuals with assets or which are capable of providing goods or services, or any other type of business. As used herein, the term “entity” will refer to the issuer (i.e., issuing body) of the security regardless of the form in which the issuer is organized and will be used interchangeably with the term issuer throughout. The term “issuer” includes any person who issues or proposes to issue any security.

An intermediated transaction between two or more participants takes place with the assistance or oversight of a third-party, the intermediary. In an intermediated transaction, participants may communicate directly or may communicate (and consummate a transaction) indirectly through one or more third-party intermediaries.

As used herein, the term intermediary shall be broadly construed to include an exchange, computerized exchange, member of an exchange, broker, dealer, market maker, specialist, clearing/settlement firm, person associated with any of these entities, or any other entity that performs the functions of an intermediary. An intermediary may be human or computerized.

An “exchange” includes any individual, organization, association, or group of persons, whether incorporated or unincorporated, that constitutes, maintains, or provides a market place or facilities, such as a physical marketplace, computer system, and/or computer network, for bringing together participants to transactions, such as purchasers and sellers of securities, or for otherwise performing, with respect to securities, the functions commonly performed by a stock exchange as that term is generally understood, and includes the facilities maintained by such exchange. A computerized exchange includes any exchange, the implementation of which is at least partially performed by a computer, including but not limited to an exchange that uses a computer configured to receive input from participants wishing to conduct transactions in securities or that is otherwise configured to provide intermediary services. Various specific examples of computerized exchanges are set forth below. The term computerized exchange is not limited to these specific examples.

The “rules” of an exchange includes the constitution, articles of incorporation, bylaws, and rules, or instruments corresponding to the foregoing, of an exchange, as well as the stated policies, practices, and interpretations of such rules.

Membership on an exchange is typically governed by the rules of the particular exchange. Thus, the term “member” may vary widely from exchange to exchange. In a typical exchange, a member of an exchange includes any person permitted to effect transactions on the exchange, without the services of another person acting as broker, or any computer(s) and/or program(s) acting in such fashion. Members typically are allowed to appoint representatives to conduct transactions on the exchange.

A “broker” includes any person engaged in the business of effecting transactions in securities for the account of others, or any computer(s) and/or program(s) acting in such fashion. A “dealer” is any person engaged in the business of effecting transaction in securities for its own account, through a broker or otherwise, or any computer(s) and/or program(s) acting in such fashion.

There are several well known examples of intermediaries that are involved mainly with trading securities commonly referred to as stocks and options. The particular intermediary to be used may differ, depending on the status of the securities as listed or unlisted. Unlisted securities are also known as over-the-counter (“OTC”) securities.

Listed stocks and options can be traded on securities exchanges such as the New York Stock Exchange (“NYSE”), the American Stock Exchange (“ASE”), the Chicago Board of Options Exchange (“CBOE”), and various other exchanges in the United States and other countries.

Over-the-counter securities can be traded on a computer network, such as the National Association of Securities Dealers Automatic Quotation system (“NASDAQ”). The NASDAQ system links securities dealers who make markets in particular OTC securities and may maintain a position in the security. The dealers post on the NASDAQ system the highest price at which they will buy a security and the lowest price at which they will sell a security. They then act as intermediaries between buyers and sellers wishing to conduct transactions in the particular securities for which they have made a market. Trading on this network is regulated by the National Association of Securities Dealers (“NASD”).

Alternately, both listed and OTC securities may be traded through intermediaries who form a “fourth” market. Fourth-market intermediaries typically do not maintain security positions in the securities they are intermediating. Instead, they act only as agents for market participants, whether as buyers or sellers, maintaining the participant's anonymity and representing the participant's interests.

Originally the fourth market was largely a network of securities brokers communicating primarily by telephone (the “Rolodex” market). Later, Instinet (operated by Reuters, New York, N.Y.) began offering partially automated intermediary services by providing a computer network through which participants could post their security trading interests and subsequently could negotiate trades using standardized messages made available by the network. More recently, POSIT (operated by ITG, New York, N.Y.) and the Arizona Stock Exchange (“AZX”) (Phoenix, Ariz.) began providing more fully automated fourth-market intermediary services. Instinet, POSIT, and AZX thus all provide varying degrees of computerized intermediary services.

A security enters the marketplace when the issuer issues the security. Issued securities may be to a select group of known individuals, to qualified or accredited private investors, or to the public at large. For example, a corporation may issue shares of stock and sell the shares at an initial public offering or other primary offerings, or the like. Alternatively, the corporation may issue shares of stock or grant a warrant for a particular number of shares in connection with consummation of an acquisition of another company. Securities may be issued in many ways and under numerous circumstances in addition to these few examples. The term “issue” is not limited to these examples, but rather includes any manner in which a security is initially provided by the issuing entity.

In the current investment system, the issuer directly obtains value for the security only in connection with its issuance. Thereafter, however, the security may be traded, may increase in value, may decrease in value, and may be the basis for any number of additional transactions. While these occurrences affect and may result in substantial benefit to the parties holding the securities and/or taking part in the transactions, the entity issuing the security does not derive any direct compensation or economic benefit for subsequent transactions involving its securities. Rather, the parties to the transaction retain all of the profit attendant to the transaction, despite the fact that the increase in value of the security, if any, is typically due, at least in part, to the hard work and success of the issuer. Additionally, the intermediaries involved in the transaction typically benefit from the transaction, regardless of whether the participants in the transaction actually profited, by charging a commission for their services as intermediaries or by taking advantage of favorable market conditions prevailing at the time of the transaction; e.g., market makers typically profit from the “spread.”

Because the issuing entity does not directly realize any economic benefit from an increase in price of the security or by having a liquid market for its securities, the motivation for the entity to maximize security value is indirect. Typically recognized indirect incentives include: enabling the company to issue additional securities at a higher price, for example in connection with an acquisition, due to the higher market value for the securities; a desire by security owners working for the entity to maximize the security's value so as to maximize the proceeds to themselves and other security owners on any sale of the entity; and the fact that certain security owners, such as shareholders, may have a right of action against the entity if the entity fails to act prudently and in the best interests of the security owners to make efforts to increase the value of the security.

### SUMMARY OF THE INVENTION

Accordingly, a need exists for a way to compensate the issuing entity when securities in the entity are involved in a transaction. According to one embodiment, the issuing entity receives a measure of economic benefit whenever a security issued by that entity is exchanged.

According to another embodiment, a method of transferring a security in an entity includes consummating by a first party and a second party a transaction in the security, the first party and the second party being distinct from the entity, and transferring a measure of economic benefit associated with the transaction to the entity. In this method, the measure of economic benefit may be transferred to the entity by either the first party or the second party.

According to another embodiment, a method of transferring a security in an entity includes consummating a transaction between a first party that sells the security at a first price and a second party that buys the security at a second price different than the first price, and transferring at least a portion of a difference between the second price and first price to the entity. In this illustrative embodiment, the issuing entity does not participate, for example as an intermediary, in the step of consummating the transaction.

According to another embodiment, a method of conducting a transaction in a security issued by an entity includes consummating a transaction in the security from a first party to a second party, the first party and the second party being different parties, the first party and the second party being different than the entity, and providing a measure of economic benefit to the entity as a result of the transaction. In this illustrative embodiment, the issuing entity does not participate in consummating the transaction.

According to another embodiment, a method of facilitating the purchase of a security issued by an entity includes facilitating payment of a first sum by a first party to a second party in connection with a transaction in the security, and facilitating payment of a second sum by at least one of the first party and the second party to the entity for the transaction in the security. In this illustrative embodiment, the entity does not facilitate payment of the second sum.

According to another embodiment, a method of transferring by a party having a first client a security issued by an entity includes obtaining by the party from the first client an instruction requesting the party to purchase the security or sell the security, executing the instruction on behalf of the party, and transferring by the party to the entity a measure of economic benefit upon execution of the instruction. In this illustrative embodiment, the party is not the issuing entity.

According to another embodiment, a method of transferring a security of an issuing entity owned by a mutual fund includes purchasing, by the mutual fund, the security, proportioning the mutual fund to determine a value of the mutual fund represented by the security, purchasing, by a first participant, a share of the mutual fund, and transferring, to the entity, a sum at least partially determined by the step of proportioning the mutual fund.

According to another embodiment, a method of structuring a sale in a security issued by an entity includes selling the security by a first party to a second party, the first and second parties being distinct entities from the issuing entity, and transferring a measure of economic benefit on the sale of the security to the entity that issued the security.

According to another embodiment, a computer-implemented method of exchanging securities issued by an entity includes receiving a first instruction to purchase at least one of the securities, receiving a second instruction to sell at least one of the securities, matching the first instruction with the second instruction to execute a transaction in the securities, and calculating a measure of economic benefit to be transferred to the entity for the transaction. Optionally, this method may also include determining if the transaction requires that a measure of economic benefit be transferred to the entity prior to calculating such measure of economic benefit, automatically transferring a measure of economic benefit to the entity, debiting an account on behalf of the entity to collect the measure of economic benefit, or transferring the measure of economic benefit to an account maintained on behalf of the entity.

According to another embodiment, a computerized exchange for exchanging securities has at least one central processing unit (CPU), and at least one memory storage device having stored therein a set of exchange instructions for execution by the CPU. In this illustrative embodiment, the set of exchange instructions providing, when so executed, at least one user with the ability to conduct a transaction, and includes a first set of instructions constructed and arranged to consummate a transaction in securities issued by an issuing entity, and a second set of instructions constructed and arranged to calculate a measure of economic benefit owed to the issuing entity as a result of the transaction.

According to another embodiment, a storage media containing software that, when executed on a computing system, performs a method for exchanging securities, the method includes the steps of consummating a transaction in securities issued by an issuing entity between a first party and a second party, the first and second party being distinct from the issuing entity, and determining a measure of economic benefit to be transferred to the issuing entity as a result of the transaction.

According to another embodiment, a measure of economic benefit calculated by the steps of ascertaining an occurrence of a transaction in securities issued by an issuing entity between participants distinct from the entity, and determining the measure of economic benefit to be transferred to the issuing entity as a result of the occurrence of the transaction.

According to another embodiment, a computer system for use in the process of exchanging securities includes a computer having at least one central processing unit, an operating system, and at least one memory storage device having stored therein a set of exchange instructions for execution by the at least one CPU. In this illustrative embodiment, the set of exchange instructions provides, when so executed, at least one user with the ability to conduct a transaction. The set of exchange instructions includes a set of instructions constructed and arranged to receive inputs from participants related to transactions involving securities, a set of instructions constructed and arranged to facilitate the transactions, and a set of instructions constructed and arranged to calculate measures of economic benefit owed to issuing entities of the securities involved in the transactions.

In this computer system, the set of exchange instructions may be configured to run autonomously on the computer to enable transactions to occur without the intervention of a human operator, or may be configured to require intervention or approval by a human operator for at least a portion of the transactions handled by the exchange. The set of exchange instructions may be configured to enable transactions to occur between anonymous parties. Additionally, the set of exchange instructions may be configured to determine a credit rating, another risk rating or a financial rating of one or more parties to the transaction.

The computer system may also include a communications unit configured and arranged to connect the computer to a wide area network or to a plurality of user terminals over a wide area network. The wide area network in this instance may include plurality of dedicated connections between the user terminals and the computer, or may include a public network such as the Internet. Communications may be encrypted using an encryption algorithm.

The set of exchange instructions may be configured to match buy and sell orders and to calculate the measure of economic benefit to be transferred to the issuing entity upon completion of the transaction, upon matching of a buy and sell order or at any point in the transaction life cycle. The set of exchange instructions may be configured to facilitate transactions 24 hours per day, seven days per week or for more limited defined trading hours and/or days. The exchange may be configured to facilitate transactions in one or more locations, globally or locally, in one or more currencies.

According to another embodiment, an exchange is configured to intermediate transactions in securities issued by at least one entity, and includes a first set of rules relating to a protocol for conducting transactions between participants in the securities, and a second set of rules relating to transfer of a measure of economic benefit to issuing entities of securities involved in transactions. The exchange may also include a third set of rules relating to payment of an exchange fee to the exchange for transactions conducted on the exchange, and at least one computer programmed to implement at least one of the first set of rules, the second set of rules and the third set of rules.

According to another embodiment, a computerized stock exchange includes a computer programmed to implement a first set of stock exchange rules relating to a protocol for conducting transactions between participants in stock on the exchange, and a computer programmed to implement a second set of stock exchange rules relating to transfer of a measure of economic benefit to entities that issued the stocks involved in the transactions on the exchange.

According to another embodiment, a set of rules governing transactions on an exchange includes rules relating to protocol for conducting transactions in securities between participants and rules relating to transfer of a measure of economic benefit to entities that issued the securities involved in the transactions.

In one or more of these embodiments, the security may take the form of a voting right in the entity, a debt interest in the entity, such as a note, bond, or debenture, an equity interest in the entity, such as stock issued by the entity, or any other security as that term is defined herein. The security may be issued by a corporation, a partnership, a limited liability company, a limited liability partnership, a trust, a labor group, a union, a mutual fund, or any other entity as that term is defined herein.

The measure of economic benefit may take the form of a percentage of the seller's profit, a percentage of an increase in value of the security from a previous transaction involving the same security, a percentage of the value of the securities involved in the transaction, a percentage of the number of securities involved in the transaction, a portion of the security itself, a right to buy other securities, a fee, a commission, a portion of a spread between any two of the sales price, ask price and bid price, a portion of a fee due to an exchange on which the transaction took place, a portion of a fee due to any intermediary, or any other quantum of value. Calculation of the measure of economic benefit is not limited to the variables above, rather, the measure of economic benefit can be derived from any one or a combination of any of these variables, or any other reasonable algorithm which can, but need not, take into account these variables.

The measure of economic benefit may be due to the entity either in a manner that is unrelated to an actual transaction, i.e., only upon initial listing of the entity's security on the exchange or upon initial listing of the entity's security and at predetermined intervals thereafter, or in a manner that is related to a transaction, i.e., for every transaction, for every predetermined number of transactions, for a sets of transactions, for randomly selected transactions, for transactions involving only particular securities issued by that entity, only for particular types of transactions, or for any other subset of transactions.

Transactions supporting transfer of a measure of economic benefit to the entity may involve a transfer of all ownership rights in the security, a transfer of partial ownership rights in the security, a transfer of voting rights associated with the security, a transaction in an options in the security, such as a purchase of the option, or a closing transaction in the option. In connection with options transactions, the transaction may be deemed to have occurred when the option expires, or when the option is exercised.

The entity may be a member of a pool of entities—a set of strategic alliances between entities, a market sector, etc. The measure of economic benefit may be transferred to the pool and subsequently distributed according to a policy of the pool of entities.

The invention also provides a computer-implemented method for assessing a payment against an event relating to an issuer's security. The method involves operating one or more computers or computer systems to receive and monitor electronic signals provided in response to, and characterizing, market activity, for a payment-generating event related to said security, identify among the monitored signals data identifying payment-generating events relating to the security in accordance with predefined payment-generating event criteria upon the occurrence of which the issuer of the security is to receive or be credited with a payment, and associate with the data identifying payment-generating events, related payment information.

Associating, in this method, can include flagging the data as related to a payment-generating event, or can include adding further data or instructions for processing the event data. The method can also include electronically communicating the related payment information and the data identifying payment-generating events to a computer system or systems for processing a payment or credit to the issuer. Market activity can include transactions in one or more securities, including the security mentioned above. The method can also involve operating one or more computers to compute the payment information and append it to the identified data. Also, debiting and crediting a plurality of accounts in response to the identification to a payment-generating event can take place. This can occur substantially in real time with the identification of a payment-generating event. Monitoring can occur prior to or during clearing and/or settling.

The payment-generating event can be a transaction unrelated instance and payment can be based upon one or more characteristics of the security-issuing entity. Payment also can be based on one or more characteristics of the market. The payment-generating event can be a transaction related instance, and the method can further include operatively connecting the computer, computers, or computer system or systems to a securities exchange system, operating the computer, computers, or computer system or systems to retrieve transaction information from the exchange system, calculating the payment, and determining at least one party responsible for making the payment. The transaction information, in one embodiment, can comprise only transactions that are completed through clearing and/or settling. The payment-generating event can be a predetermined triggering event and may be identified according to a predefined payment calculation and/or payment configuration. Payment may be due and owing to the issuing entity and the issuing entity may direct the payment to another entity, which can be an entity associated with the security issuer. The other entity also can be an entity federated with the security issuer.

Crediting the payment to the issuing entity can include crediting or paying the payment to an entity other than the issuing entity on behalf of the issuing entity. The payment-generating event can be an associated transaction.

Another embodiment of the invention involves a computer-implemented exchange system configured to intermediate transactions and securities issued by at least one entity, the exchange system comprising at least one exchange, each exchange comprising first computer means for conducting the transactions according to a first set of rules relating to a predetermined protocol, and second computer means for conducting, according to a second set of rules, transfers of a measure of economic benefit to issuing entities of securities involved in the transactions, and if there are two or more exchanges, means permitting said exchanges to intercommunicate.

The measure of economic benefit may be due to the issuing entity upon the occurrence of a transaction on related instance, or may be due to the issuing entity upon the occurrence of a transaction related instance. At least one of the first and second computer means may comprise at least one computer programmed to implement at least a corresponding one of the first set of rules and the second set of rules. The exchange system can further comprise at least one network of exchanges wherein the exchange network is configured to have a centralized access point for easier exchange in the exchange network. At least one of the standalone exchanges can be an issuer-exchange, and the issuer exchange can be configured to also trade securities other than the issuer's securities. The issuer-exchange can be hosted by a third party, and access to the hosted issuer-exchange can be provided through one or more of a link and a framed window into the hosted issuer exchange.

The invention also provides a computerized payment calculation system for assessing a payment against an issuer's security, comprising a computing device programmed to implement a set of rules for assessing the payment, wherein the computing device is configured to communicate with a computerized stock exchange. The computing device can be configured to communicate with a historical system of the computerized stock exchange.

Another embodiment of the invention involves a storage media containing software that, when executed on a computing system, performs a method for assessing a payment against an issuer's security, the method comprising receiving and monitoring electronic signals provided in response to, and characterizing, market activity, for a payment-generating event related to said security, identifying among the monitored signals data identifying payment-generating events relating to the security in accordance with predefined payment-generating event criteria upon the occurrence of which the issuer of the security is to receive or be credited with a payment, and associating with the data identifying payment-generating events related payment information.

The invention also provides a computer implemented method for assessing a royalty against an issuer's security. The method involves monitoring market activity for a royalty generating event, identifying the royalty generating event, and flagging and/or stamping the royalty generating event identified with royalty information.

In another embodiment the invention provides a method for defining a royalty calculation and/or payment configuration comprising configuring one or more rules for calculating a royalty to be assessed against an issuer's security, and configuring one or more rules for allocating the royalty to one or more royalty receiving entities.

The invention also provides an exchange configured to intermediate transactions and securities issued by at least one entity. The exchange comprises a first set of rules relating to a protocol for conducting the transactions in the securities, and a second set of rules relating to transfer of a measure of economic benefit to issuing entities of securities involved in the transactions.

The invention also provides a computerized royalty calculation system for assessing a royalty against an issuer's security, comprising a computing device programmed to implement a set of rules for assessing the royalty, wherein the computing device is configured to communicate with a computerized stock exchange.

The invention also provides a storage media containing software that, when executed on a computing system, performs a method for assessing a royalty against an issuer's security, the method comprising the steps of monitoring market activity for a royalty generating event, identifying the royalty generating event, and flagging and or stamping the royalty generating event identified with royalty information.

As used herein, “measure of economic benefit” and “economic benefit” may include any form of assigning or transferring value (positive or negative) and include, but are not limited to, a royalty(ies).

Terms expressed herein in the singular shall be understood to encompass the plural and terms expressed herein in the plural are intended to encompass the singular, unless from context it appears otherwise.

### BRIEF DESCRIPTION OF THE DRAWINGS

This invention is pointed out with particularity in the appended claims. The above and further advantages of this invention may be better understood by referring to the following description when taken in conjunction with the accompanying drawings. The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a functional block diagram of an illustrative method of transferring an economic benefit to an issuing entity when its securities are involved in a transaction;

FIG. 2 is a functional block diagram of an illustrative computerized exchange for use in connection with one embodiment of this invention;

FIG. 3 is a functional block diagram of the computerized exchange of FIG. 2 connected to a plurality of trading computers via a wide area network;

FIG. 4 is a diagram of the flow of one embodiment of a software program to be executed by the computerized exchange of FIG. 2 in connection with a simple transaction involving buy and sell orders of securities;

FIG. 5 is a functional block diagram of an illustrative algorithm for use by the computerized exchange of FIG. 2 during a calculation of the measure of economic benefit;

FIG. 6 is a functional block diagram of an illustrative method of conducting a transaction directly between parties and transferring a measure of an economic benefit to the entity that issued the security involved in the transaction;

FIG. 7 is a functional block diagram of an illustrative method of conducting a transaction between parties with intermediaries and transferring a measure of an economic benefit to the entity that issued the security involved in the transaction;

FIG. 8 is a functional block diagram of an illustrative method of conducting a transaction involving shares of a closed end mutual fund and transferring a measure of an economic benefit to the entities that issued the securities owned by the mutual fund;

FIG. 9 is a functional block diagram of an illustrative method of conducting a transaction involving shares of a open ended mutual fund and transferring a measure of an economic benefit to the entities that issued the securities owned by the mutual fund;

FIG. 10 is a functional block diagram of an illustrative method of conducting a transaction involving options in securities of an entity and transferring a measure of an economic benefit to the entity that issued the securities on which the option is based;

FIG. 11a is a diagram of a representative network topology for providing information accessibility and transferability according to one possible embodiment of the present invention;

FIG. 11b is a diagram illustrating some of the potential alternative ways a client can access various embodiments of the computerized exchange system of the present invention;

FIG. 11c is a diagram of an alternative network topology for communications directly between one or more clients and one exchange system over a private network;

FIG. 11d is a diagram of an alternative network topology for communications directly between one or more clients and one or more exchange systems over a public network;

FIG. 12a is a diagram of a royalty calculation system according to one embodiment of the present invention;

FIG. 12b is a diagram of a royalty calculation system according to another embodiment of the present invention;

FIG. 12c is a diagram of a royalty calculation system according to another embodiment of the present invention;

FIG. 12d is a diagram of a computerized exchange system configured with a combination of commercial of the shelf software and special purpose software according to one embodiment of the present invention;

FIG. 12e is a diagram of a computerized exchange system configured with special purpose software according to one embodiment of the present invention;

FIG. 13a is a function block diagram illustrating one possible method for electronically submitting an issuer's royalty calculation/payment configuration;

FIG. 13b is a representation of one possible embodiment of the issuer royalty calculation/payout configuration window depicted in FIG. 13a; and

FIG. 14 is a functional block diagram of an illustrative method of conducting an associated transaction.

### DETAILED DESCRIPTION

This invention, in one aspect, relates to a method of conducting transactions in securities that will ultimately result in the transfer of a measure of an economic benefit to the issuing entity whenever a security issued by the entity is involved in a transaction. According to one illustrative embodiment of the present invention, for all or a selected subset of transactions, a measure of an economic benefit is transferred to the entity issuing the security involved in the transaction. The measure of economic benefit may be considered to be a form of royalty or commission, for example a percentage of the seller's profit, or any other quantum of value, as discussed in greater detail below. As used herein, unless it appears otherwise from context, the term “royalty,” however the royalty may be computed, may be used interchangeably with “economic benefit” though a royalty also is used to specify one form of economic benefit. The value or benefit that becomes due and owing to an entity from a royalty or economic benefit may be related to certain events including but not limited to a transaction in its security or an associated transaction in another's security or in a manner that is not related to a transaction in its security or an associated transaction in another's security. For example, a measure of economic benefit may become due and owing to the issuing entity in a manner that is not related to each individual transaction or to a selected subset of transactions (transaction-unrelated instances) but instead may be based upon, for example, only the initial listing of the entity's security on the exchange, or, upon the initial listing and some predetermined intervals thereafter.

In other examples, the economic benefit could be based upon some characteristic of the issuing entity. For example, a characteristic of the issuing entity that might determine the measure of economic benefit that an entity would receive in these transaction-unrelated instances could be market forecasts, market evaluations, analyst predictions, history of trading volume on other exchanges, and the like. Alternatively, an agreement or arrangement might provide that the measure of economic benefit is unrelated to any characteristic of the issuing entity, but instead is based upon, for example, some characteristic of the market itself or a characteristic of any subset of the market (e.g., performance of a market sector, performance of one of the market indices, etc.). It should also be noted that the present invention is not limited to an issuer receiving a royalty or measure of economic benefit. For example, the exchange may be compensated through the same or different mechanisms as the issuer. The exchange may be compensated at the same time as the issuer or at different times than the issuer. The computer systems and/or software for computing and/or compensating the exchange may be the same as, or separate from, the computer systems and/or software for computing and/or compensating the issuer.

Another aspect of this invention relates to an exchange having rules of operation designed to transfer a measure of an economic benefit to the issuing entity whenever a security issued by the entity is involved in a transaction or whenever a predetermined triggering event occurs. A triggering event may include a variety of different deterministic or stochastic events or combinations thereof. Triggering events may be deemed to have occurred in a variety of different circumstances. Such circumstances may be determined through consideration of, including among other things: the number of shares or securities traded; an elapsed time; the type of shares or securities traded; the time the trade was made or executed; payment terms; margin; short selling; long positions; length of time security is held; quantity of security; quantity of security available; quantity of security issued; quantity of security held; quantity of security held by the buyer, seller or third party; intention of buying or selling; announcement of buying or selling; an option(s); a derivative(s); the place a trade was made or executed; the currency or other value transferred in exchange for the security; current or future state of affairs; the interest rate; availability of goods or services; the performance of another entity; the performance of a government; profits; revenues; debt; cash; cash equivalents; earnings; losses; comparisons; the type of or specific buyer or seller of the security; the quantity of buyers or sellers; governmental regulation; the profit or loss made by one or more parties; the spread; market performance; the performance of a market sector; the launch or discontinuance of a business endeavor; reorganization; acquisition; sale; distribution; dividend; announcement; issuer performance; exchange performance; or any other such metric whether related to the exchange of securities or not and whether deterministic or randomly occurring events and any combination or derivative of the above. Again, the present invention is not limited to an issuer receiving a royalty or measure of economic benefit. For example, the exchange may be compensated through the same or different mechanisms as the issuer. The exchange may be compensated at the same time as the issuer or at different times than the issuer. The computer systems and/or software for computing and/or compensating the exchange may be the same as, or separate from, the computer systems and/or software for computing and/or compensating the issuer.

The exchange may take the form of a traditional exchange, such as the NYSE, or may involve a computerized exchange, such as the exchange disclosed in U.S. Pat. No. 5,873,071, entitled COMPUTER METHOD AND SYSTEM FOR INTERMEDIATED EXCHANGE OF COMMODITIES, assigned to ITG, Inc., the content of which is hereby incorporated by reference, or any combination thereof. The invention is not limited to an implementation according to these exemplary exchanges, but rather includes any exchange which can either be adapted or initially designed to transfer a measure of economic benefit to the issuing entity, as discussed in greater detail below. Further, the exchange may take the form of a combination of one or more exchanges, a network of exchanges or even a network of exchange networks.

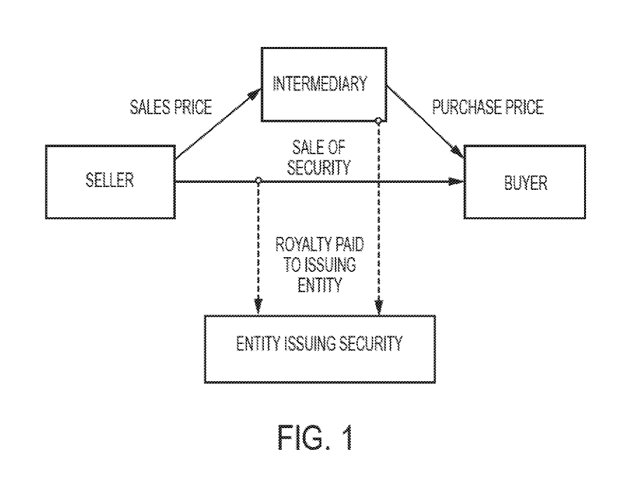

As shown in FIG. 1, a typical transaction in a security may either be direct or intermediated. For example, in a direct transaction, a security is sold by a seller to a buyer. In an intermediated transaction the security is sold from a seller to a buyer with the assistance of one or more intermediaries. In either instance, according to this invention, a measure of economic benefit is transferred to the entity issuing the security as a result of the transaction involving the security.

The measure of economic benefit in this instance may take the form of any benefit to the issuing entity or of any detriment to one of the other parties or intermediaries involved in the transaction. For example, the measure of economic benefit, may include a percentage of the seller's profit, a percentage of the value of the securities involved in the transaction, a percentage of a tracking index (e.g. ask or bid price), a percentage of the number of securities involved in the transaction, a portion of the security itself, a right to buy other securities, a straight fee, a commission, a portion of a spread between any two of the sales price, ask price and bid price, a portion of a fee due to the exchange on which the transaction took place, a portion of a fee due to any intermediary, or any other measure of value. Calculation of the measure of economic benefit is not limited to the variables above; rather, the measure of economic benefit can be derived from any one or more of these or other variables or any combination of these or other variables. Any reasonable algorithm which can, but need not, take into account these variables may be formulated, implemented and/or programmed into a computer system or computer readable medium to provide a basis for calculating the measure of economic benefit to be transferred to the issuing entity.

As previously stated above, the terms “economic benefit” and “royalty” as used herein may be used interchangeably to refer to the value that is to be transferred to the entity in connection with transactions subsequent to the issuance of a security, however computed, and therefore the use of the term royalty is not meant to be limited to any particular form of economic benefit or to any particular means of computing such economic benefit.

Alternatively, to realize tax advantages, financial incentives, non-financial incentives, or the like, the entity may choose to direct that the benefit be transferred to someone else or to some other entity; e.g., a charity, affiliate, related company, any not-for-profit organization, a partner entity, affiliate, subsidiary or the like. For instance, an entity may choose to be party to an agreement with one or more additional entities wherein the entities may choose to have the benefit due and owing on transactions in their security to be transferred to another entity. Such a transaction may be referred to as an associated transaction. Establishing the association of entities may be accomplished in any number of ways. For example, when an entity lists a security on an exchange, it could choose to be associated with one or more entities that share one or more similar characteristics. The characteristics of entities which may be the basis for forming associations could be based on, for example, a business relationship or understanding, comparable volume of trading, annual/quarterly revenues and/or profits, market capitalization, common commercial or government marketplace for their services and/or products, or any other mechanism for determining equitable association. Alternatively, a set of entities may form a federation of exchanges in which each entity establishes a securities exchange for one or more other entities in the federation. For instance, a member entity of the federation operating its own exchange would receive a measure of economic benefit for transactions in other member entities' securities, while the trading of its own securities on some other member entities' exchange would provide a measure of economic benefit to that member entity.

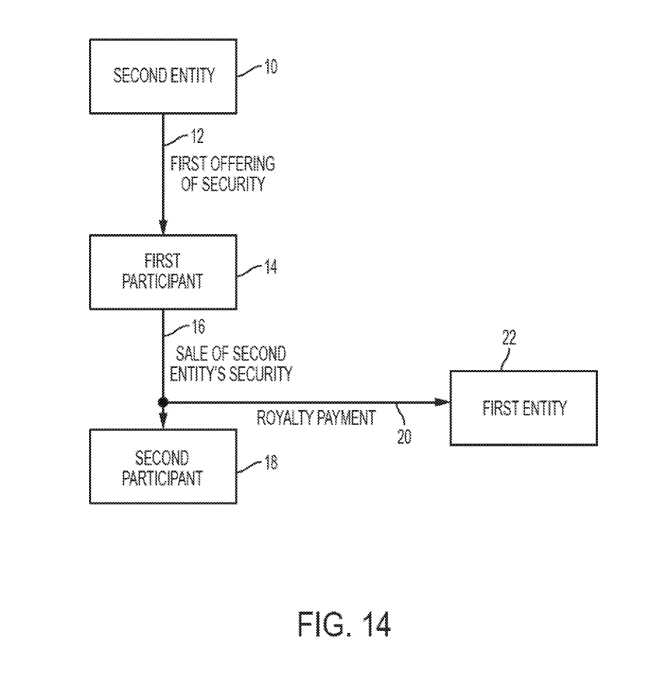

FIG. 14 depicts one illustrative method wherein a first entity may receive a measure of economic benefit for an associated transaction involving securities issued by a second entity. The second entity 10 issues a security 12 in a first offering to a first participant 14. The first participant 14 subsequently conducts a transaction 16 involving the security issued by the second entity with a second participant 18. A byproduct of that transaction is to transfer a royalty 20 to the first entity. Although the illustrated transaction resulting in generation of a royalty in this scenario is the second transaction (the first transaction occurs when the security is first offered to the first participant) the invention is not limited in this respect, and subsequent transactions likewise may be royalty generating transactions. Stated differently, royalty bearing transactions may occur for every transaction n where n>1.

A measure of economic benefit may be due and owing, or transferred, to the entity in a manner that is unrelated to an actual transaction in either the entity's security or another entity's security, or in a manner that is related to an actual transaction in either the entity's security or another entity's security. Illustrative examples of an unrelated manner may include a measure of economic benefit being due and owing, or transferred, only upon initial listing of the entity's security on the exchange or upon initial listing of the entity's security and at predetermined intervals thereafter. Illustrative examples of a related manner may include a measure of economic benefit being due and owing, or transferred, for every transaction, for every predetermined number of transactions, for various sets or subsets of transactions, for randomly selected transactions, for transactions involving only particular securities or for any other subset of transactions.

It should also be emphasized that the transactions that result in a measure of economic benefit becoming due and owing, or transferred, to an entity need not be transactions in that entity's security but may also involve transactions in another entity's security. Furthermore, the measure of economic benefit due and owing, or transferred, to an entity may be related to transactions in that entity's security in combination with one or more other entities' securities or combined transactions in one or more other entities' securities. In one illustrative example, a measure of economic benefit is due and owing, or transferred, to a first entity upon the completion of a transaction in a second entity's security. The second entity may be related in some way to the first entity or not. In addition, there may be one or multiple second entities. In some examples the transaction in the second entity's security may be made possible by, or result from, the first entity's direction/redirection of the user/participant to a particular computerized exchange. Such direction or redirection may take the form of a referral, an embedded link on the first entity's web site or portal, framing, co-branding, or the like. There are many techniques/methods for referring, directing and/or redirecting user's not described above but that would be readily understood by person's of ordinary skill in the art to be equivalent, or interchangeable, with these techniques/methods and therefore a particular embodiment of the present invention is not limited in this respect to these disclosed techniques/methods.

The transfer of economic benefit to the entity may occur only in connection with particular types of transactions, such as the transfer of all or partial ownership rights in a security, the transfer of all or partial voting rights in the security, or when options in the security are written, purchased, sold, exercised, or otherwise expire. Many other types of transactions may constitute economic-benefit-generating, or royalty-generating, transactions and the invention is not limited to only calculating a measure of economic benefit in connection with a particular type of transaction or group of transactions.

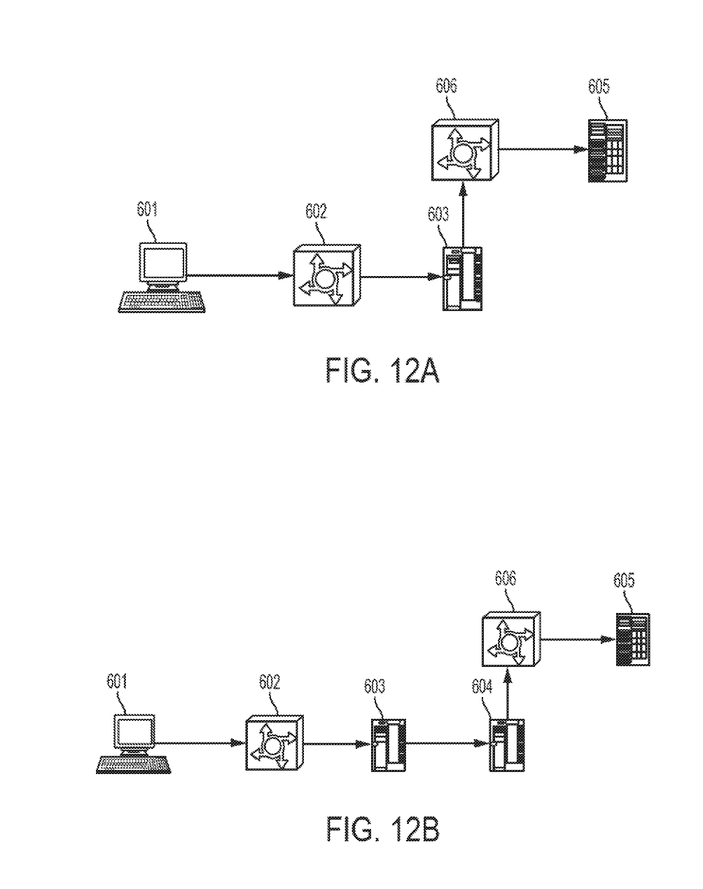

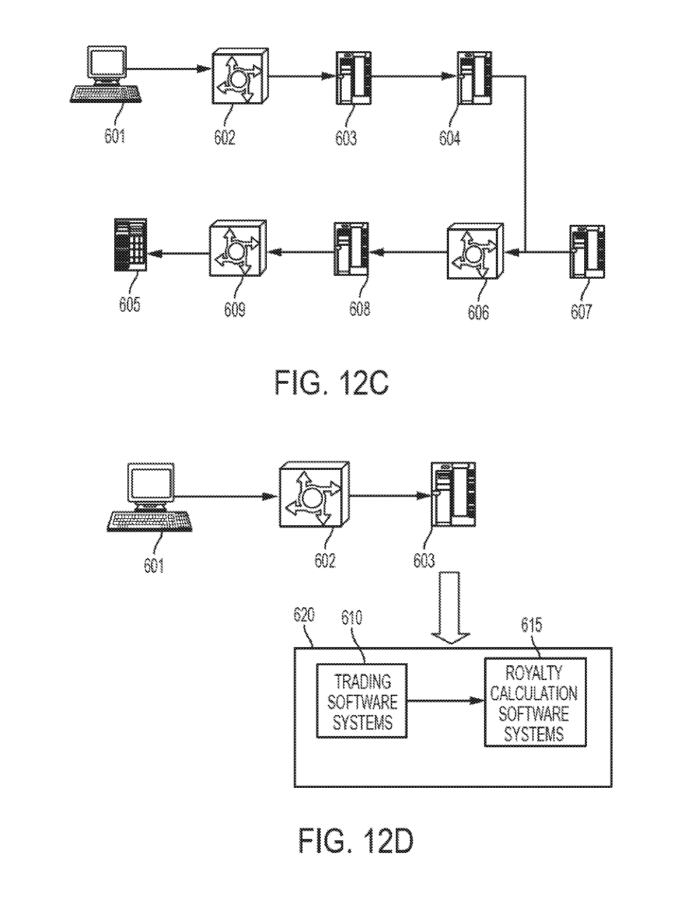

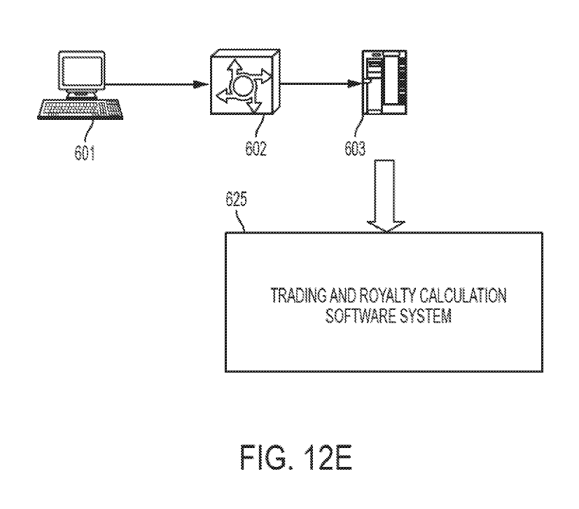

A computer system forming a computerized exchange may be provided to enable transactions in securities and/or to calculate measures of economic benefit transferable to the issuing entity for transactions involving securities issued by that entity or another entity, as described above. In one embodiment, an exchange is formed as a computer program as illustrated in FIG. 12e, or collection of computer programs as illustrated in FIG. 12d, which can either be distributed separately on one or more computer-readable storage medium or pre-installed on one or more computer systems. The collection of computer programs 620 may, for example, be a combination of commercial off-the-shelf programs and special purpose programs 610, 615, or simply an all-in-one, off-the-shelf solution or as illustrated in FIG. 12e a combination of all special purpose programs forming one integrated solution 625, for accomplishing the various aspects of an operational exchange and the calculation of a royalty or measure of economic benefit due and owing to an issuer or other party.

The program or programs can be adapted to run on a computer or group/network of computers configured to receive input from participants wishing to conduct transactions in securities and to enable securities to be exchanged. The computer, in this instance, may be configured to run autonomously to enable transactions to occur (without the intervention of a human operator), or may require intervention or approval for all, a selected subset, or particular classes of transactions. The invention is not limited to the disclosed embodiments, and may take on many different forms depending on the particular requirements of the exchange, the rules of the exchange, and the type of computer equipment employed.

Alternatively, as shown in FIG. 12a, a royalty calculation system 605 forming only a part of a computerized exchange 603 may be provided that monitors for royalty generating transactions at the front-end and subsequently either plays a more passive role and flags/stamps this transaction as a royalty-bearing transaction to be processed accordingly at the time of clearing/settling or plays a more active role ranging possibly from immediately computing the royalty owed to the issuing entity for such royalty generating transactions and flagging/stamping the transaction with this information for subsequent processing to possibly not only computing the royalty and flagging/stamping the transaction but also to debiting and crediting the appropriate accounts in a real-time, or near real-time manner. For instance, the royalty calculation system 605 may connect to the exchange system 603 via any possible communications network 606. The royalty calculation system could then retrieve information to calculate the royalty and determine the party responsible for payment of the royalty. Preferably, where the royalty is immediately assessed against the parties and the respective accounts are appropriately debited/credited, the entire transaction, including clearing/settling, occurs in real-time, with a fixed or variable delay or as close to real-time as is practicable. In some embodiments the system is programmed to ensure that only transactions that are completed through clearing/settling result in the payment of a royalty or the transfer of a measure of economic benefit. In one such embodiment, the computer system may be viewed as a network appliance 605 which contains programming and standard communications equipment that allows it to be modular in design so that it may be “plugged-in” to an existing exchange system, much like a router or switch is added to a computer network. Such a network appliance embodiment may be either self-configuring, i.e., plug-and-play, or may be configurable by a human operator directly or through remote means. The royalty calculation system may in some embodiments be a software system or “plug-in”.

Alternatively, as depicted in FIG. 12b, a royalty calculation system 605 forming only a part of a computerized exchange system 603 may be provided that monitors for royalty generating transactions at the back-end and subsequently either plays a more passive role and flags/stamps this transaction as a royalty-bearing transaction to be processed accordingly during clearing/settling or plays a more active role ranging possibly from immediately computing the royalty owed to the issuing entity for such royalty generating transactions and flagging/stamping the transaction with this information for subsequent processing to possibly not only computing the royalty and flagging/stamping the transaction but also to debiting and crediting the appropriate accounts in a real-time manner. For example, FIG. 12b illustrates how traders 601 may connect via any possible communications network 602 to the exchange system 603 to place orders for execution. The exchange system transfers the information associated with the transactions that have occurred to the historical system 604. The historical system may store data from many transactions over lengthy periods of time. In this illustrative embodiment, either the exchange system 603 or the historical system 604 may clear and settle the transaction and the royalty calculation system 605 can connect via any possible communications network 606 to the historical system 604 to retrieve the necessary information to calculate the royalty due and owing to the issuer or the appropriate party and determine the party responsible for payment.

One possible alternative embodiment of the back-end system previously described is depicted in FIG. 12c. In an illustrative example of this embodiment, a third party exchange information consolidation system 608 may connect to the historical system 604 via any possible communications network 606 to collect information on the transactions that have occurred on that exchange 603. The third party exchange information consolidation system 608 can connect to any number of additional exchange systems 607, and consolidate the information from those additional exchanges. In this instance, the royalty calculation system 605 can connect to the third party exchange information consolidation system 608 to retrieve the necessary information to calculate the royalty due and owing the issuer or other party and ascertain the party responsible for payment of such royalty.

Still yet another alternative may be to provide a computer program, or collection of computer programs, which can be distributed separately on one or more computer-readable storage medium for installation on one or more computer systems forming an exchange. The distributed program or programs can be adapted to run on a computer or group/network of computers comprising an existing exchange that can conduct transactions in securities and enable securities to be exchanged. For example, the program, or programs, may consist of a set of instructions which modify, alter, or enable the existing exchange to monitor for royalty generating transactions and subsequently either plays a more passive role and flags/stamps this transaction as a royalty-bearing transaction to be processed accordingly at the time of clearing/settling or plays a more active role by immediately computing the royalty owed to the issuing entity for such royalty generating transactions. Such a distributed program or programs may be stand-alone programs or may be software components or libraries which are easily integrated into and used by an existing exchange system through a series of routine calls to services exposed by the components or libraries. The invention is not limited to the network appliance or distributed program(s) discussed above and therefore it should be understood that the particular implementation may take on many different forms depending on the particular requirements of the exchange, the rules of the exchange, the software running the exchange processes, front/back-office software and the type of computer equipment employed.

In addition, since as previously stated, the present invention is not limited to an issuer receiving a royalty or measure of economic benefit, the exchange may be compensated through the same or different mechanisms as the issuer, the exchange may be compensated at the same time or at a different time than the issuer and the computer systems and/or software for computing and/or compensating the exchange may be the same as, or separate from, the computer systems and/or software for computing and/or compensating the issuer.

A computerized exchange, may optionally, but need not necessarily, perform additional intermediary functions, including enabling transactions to occur between anonymous parties, determining credit or financial abilities of the parties to the transaction, and any other functions commonly performed by one or more intermediaries, clearing agencies, transfer agents, or exchange members. Therefore, it can be readily understood by a person of ordinary skill in the art that the alternative methods and procedures described herein may apply to an issuer/entity acting in any of the capacities of the various parties set forth herein. For example, the issuer can own, operate and/or maintain the exchange, the issuer can be a broker for a transaction, the issuer can be a market maker on its own exchange or on any other exchange, the issuer can take on the role of specialist, the issuer can take on the role of counter-party, the issuer can take on the role of a clearing/settling agent, or the like. Any role that is currently performed by third parties in transactions involving the exchange of securities can be taken on by the issuer. In these instances, the issuer may forego the royalty that would normally be due and owing, may opt to reduce the royalty payment or may opt for any variation/combination thereof.

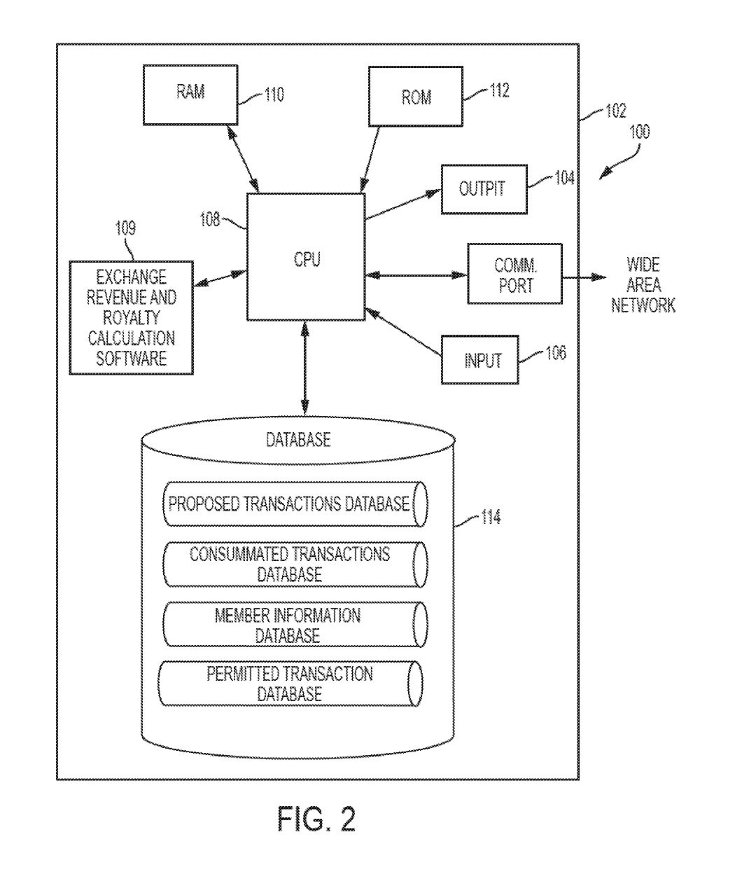

In the embodiment shown in FIG. 2, a computer system 100 for implementing the method of exchanging securities of FIG. 1 includes at least one main unit 102 configured to communicate over a communications network such as, for example, a local area network, a wide area network, a wireless network (radio frequency, microwave, satellite, electromagnetic radiation, or the like) or a communications network that consists of any combination of the foregoing. The computer system 100 may be connected to the communications network through any possible means such as, for example, cable, fiber, digital subscriber line (DSL), plain old telephone service (POTS), or the like. The main unit 102 may include at least one processor (CPU 108) capable of running exchange revenue and royalty calculation software 109, connected to a memory system including various memory devices, such as random access memory RAM 110, read only memory ROM 112, and one or more databases 114. The one or more databases may be local, as depicted in FIG. 2, or remote; they may be located all on one computer system or distributed among more than one computer system; they may be kept both locally and remotely; they may also be maintained in such a manner that a master database or databases is/are maintained while copies are distributed to remote locations and updated according to the specific requirements of the particular implementation.

The computer system may be a general purpose computer system which is programmable using one or more computer programming languages, such as C, C++, Java, Visual Basic and/or other language, such as scripting languages like Perl, Active Server Pages, and/or Java Server Pages or even assembly language. The computer system may also be specially programmed, special purpose hardware, or an application specific integrated circuit (ASIC).

In a general purpose computer system, the processor is typically a commercially available microprocessor, such as a Pentium series processor available from Intel, or other similar commercially available processor. Such a microprocessor executes a program called an operating system, such as UNIX, Linux, MacOS, BeOS, SunOS, Windows NT, Windows 95, 98, or 2000, or any other commercially available operating system, which controls the execution of other computer programs and provides scheduling, debugging, input/output control, user interface management, accounting, compilation, storage assignment, data management, memory management, network services, communication control and related services, and many other functions.

The processor may also execute additional infrastructure programs and/or services integrated with the operating system. These additional infrastructure programs could include commercially available financial exchange solutions, an integration of commercially available software that can form the services of the exchange, application servers, web servers, scripting engines, firewall servers and the like.

A commercially available financial exchange system may include a complete software solution which provides the necessary capabilities to form, operate, manage and/or regulate a market for the trading of securities or any appropriate portion thereof. A commercially available financial exchange may consist of integrated modules providing services for, e.g., order entry, order management, order execution, market data distribution, market data generation, clearing and settling, market regulation and surveillance, data feeds, reporting, member services, and the like. Examples of commercially available solutions include TIBExchange from TIBCO Financial Technology, Inc. and OM CLICK Exchange System from for financial exchange products and SECUR, also from OMGroup, Inc. for clearing and settling. It should be understood that these are only examples of presently available solutions and that any solution which provides the necessary functionality may be used.

As is generally understood in the art, an application server may include software which provides a consistent framework for the overall structure of programs for any application, in this case the exchange. An application server may provide services supporting database persistence to multiple different database technologies, transaction management, security, authentication, threading and thread-safe operation, server process hosting, remote communication, object naming, event handling, asynchronous and synchronous messaging, and many other services. The application server infrastructure could be based on CORBA, COM/DCOM, COM+, Enterprise Java Beans (EJB), and/or any other technology that provides infrastructure supporting the development of applications on an operating system. Example of application servers includes but is not limited to WebLogic from BEA Systems, Web Sphere from IBM, Orbix from Iona Technologies, and COM+ from Microsoft.

The processor, operating system, and additional infrastructure software may be used as a computer platform for which application programs in high-level programming languages are written.

The database 114 may be any kind of database, including a relational database, object-oriented database, unstructured database, multi-dimensional database, time-series database or other database. Example relational databases include Oracle 8I from Oracle Corporation of Redwood City, Calif.; Informix Dynamic Server from Informix Software, Inc. of Menlo Park, Calif.; DB2 from International Business Machines of Yorktown Heights, N.Y.; and Access from Microsoft Corporation of Redmond, Wash. An example of an object-oriented database is ObjectStore from Object Design of Burlington, Mass. An example of a time-series database for financial applications is TimeSquared from Saliton Associates of Toronto, Canada. An example of an unstructured database is Notes from the Lotus Corporation, of Cambridge, Mass. A database also may be constructed using a flat file system, for example by using files with character-delimited fields, such as in early versions of dBASE, now known as Visual dBASE from Inprise Corp. of Scotts Valley, Calif., formerly Borland International Corp.

The main unit 102 may optionally include or be connected to an output device 104 configured to provide information to a user. Example output devices include cathode ray tube (CRT) displays, liquid crystal displays (LCD) and other video output devices, printers, communication devices such as modems, storage devices such as a magnetic disk, optical disk, magneto-optical disk, tape, or the like, and audio or video output devices. Likewise, one or more input devices 106 may be included with or connected to the main unit 102 and configured to enable a user to input information to the main unit 102. Example input devices include a keyboard, keypad, track ball, mouse, pen and tablet, voice-control device, communication device, and data input devices such as audio and video capture devices. It should be understood that the invention is not limited to the particular input or output devices used in combination with the computer system or to those described herein.

It also should be understood that the invention is not limited to a particular computer platform, particular processor, or particular high-level programming language. Additionally, the computer system may be a multiprocessor computer system, a massively-parallel computer system or may include multiple computers connected over a computer network and configured to perform parallel processing and/or distributed processing. It further should be understood that each module or step shown in the accompanying figures and the sub steps or subparts shown in the remaining figures may correspond to separate modules of a computer program, or may be separate computer programs. Such modules may be operable on separate computers. The data produced by these components may be stored in a memory system or transmitted between computer systems.

Such a system may be implemented in software, hardware, or firmware, or any combination thereof. Additionally, the system is not necessarily static but may be dynamically reprogrammed or reconfigured, either manually or automatically through some form of artificial intelligence or expert-based system, as those terms are currently understood. The various elements of the method of exchanging securities disclosed herein, either individually or in combination, may be implemented as a computer program product, such as the Exchange Revenue and Royalty Calculation Software 109, tangibly embodied in a machine-readable storage device or medium for execution by the computer processor 108. Various steps of the process may be performed by the computer processor 108 executing the program 109 tangibly embodied on a computer-readable medium to perform functions by operating on input and generating output. Computer programming languages suitable for implementing such a system include procedural programming languages, object-oriented programming languages, and combinations of the two.

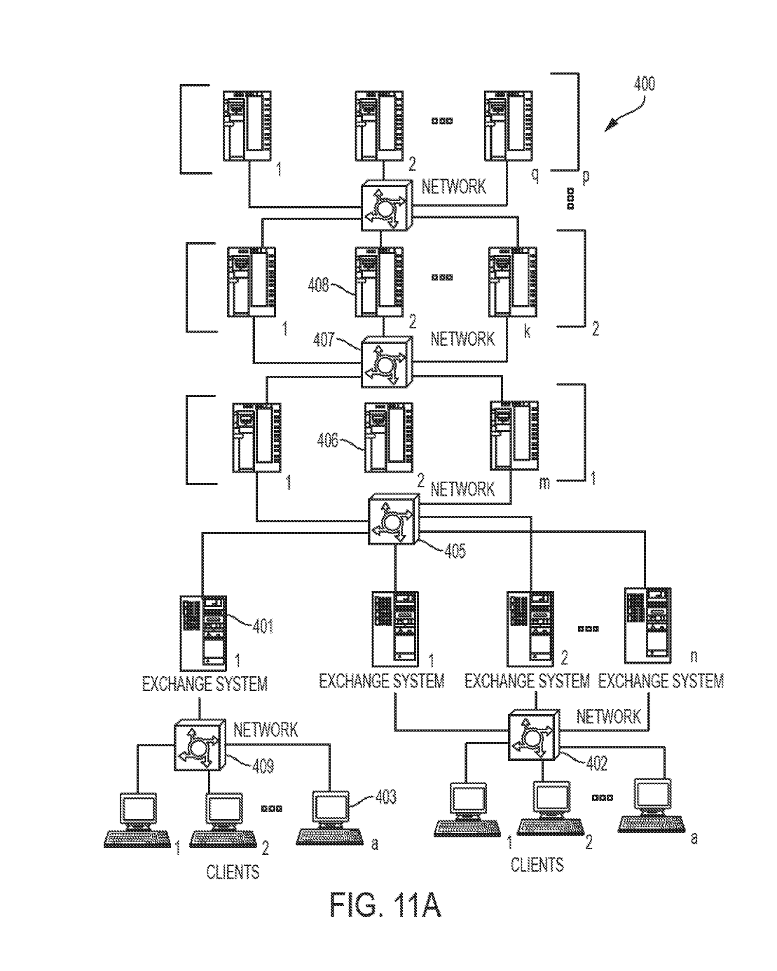

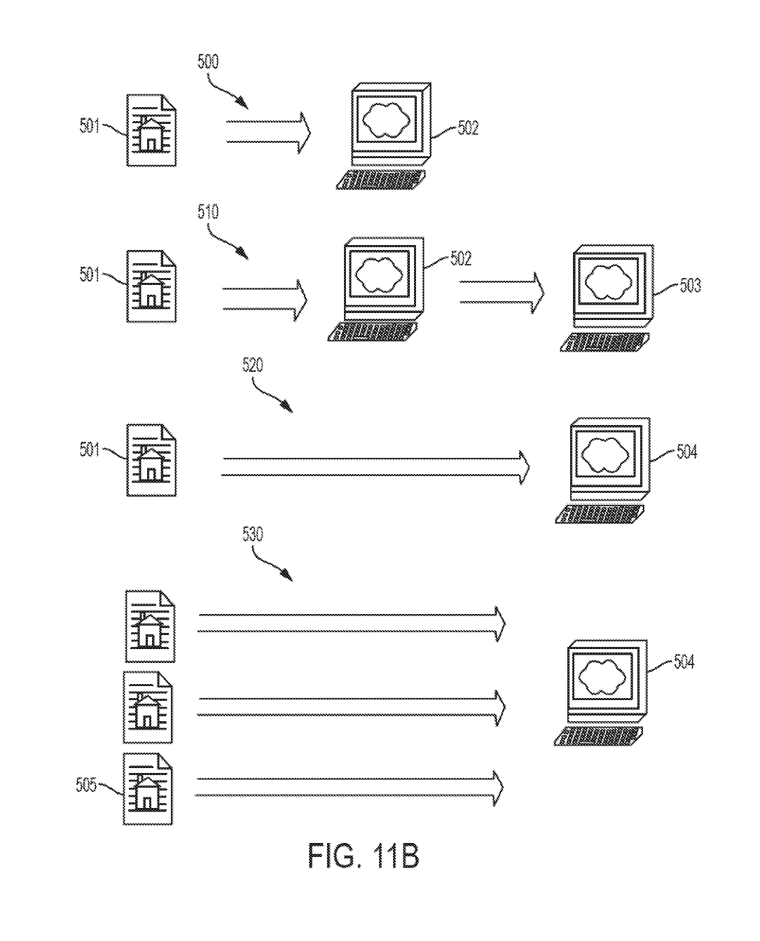

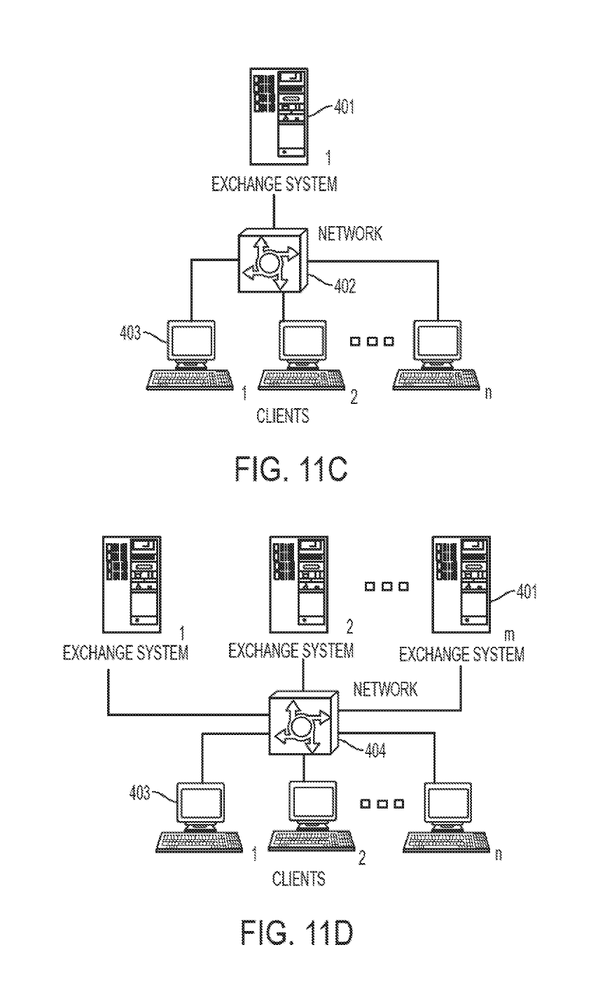

FIG. 11a depicts one possible embodiment of the overall system illustrating an implementation of a computerized exchange system 400 according to the present invention. The transfer of securities can occur through several alternative and/or complementary methods and through several alternative and/or complementary implementations of the system. In one embodiment, the issuer may wish to act as an exchange (issuer-exchange). For example, an exchange system 401, including the software, hardware and operating system necessary to implement the functions of the exchange, can be provided to an issuer to execute these functions for the issuer's security. In such an exchange system, an issuer-exchange may elect to own, operate and/or maintain its own exchange system in a standalone configuration. FIG. 11c depicts one such standalone configuration wherein in one embodiment the exchange is an issuer-exchange that could provide for the exchange of only its own securities or its own and other's securities. Investors interested in exchanging the securities could be required to access the exchange system through, for example, either a direct/dedicated dial-up connection (FIG. 11c) or through a public network such as the Internet (FIG. 11d).

In another embodiment an issuer-exchange may elect to own, operate and/or maintain its own exchange system in whole or in part or an issuer may wish to list securities on an exchange which is owned, operated, directed, controlled, affiliated and/or maintained by entities other than the issuer where the exchange system is configured in a networked configuration wherein the exchange may be networked to other exchange systems, other traditional exchange systems and/or third party service systems for performing additional services such as, clearing and settling of transactions, to form a network of exchanges, or “exchange network.” It should be understood that an exchange network need not necessarily include an issuer-exchange but may simply include exchange systems owned, operated, directed, controlled, affiliated and/or maintained, in whole or in part, by parties other than the issuer and/or third party service systems. In such a networked configuration, exchange of the securities available on each exchange may be facilitated through the provision of, for example, a centralized access point, or portal, to each issuer-exchange that is part of the network exchange. Such a network exchange could provide a convenient access point for exchanging securities on the various standalone exchange systems, which may be issuer owned, operated, directed, controlled, affiliated and/or maintained, in whole or in part, or not at all, traditional exchange systems and/or third party service systems.

Additionally, each exchange network so formed can be part of a larger network which connects, or networks, these various exchange networks to form a network of exchange networks. An exchange network could be constructed in a variety of different formats and/or based on a variety of different criteria. For example, an exchange network can be based on issuer characteristics that may include similar market sector/industrial affiliation, corporate affiliation, joint venture agreement, customer base, market capitalization, trading volume, or any other basis upon which an issuer exchange may elect to become part of an exchange network. In one embodiment such an exchange network could allow for the exchange of the securities of issuer-exchanges that form a network exchange or of one or more issuers who have elected to have their securities exchanged on one or more of the issuer-exchanges (described in more detail below) or other exchanges that form the network exchange. In one embodiment of the invention a network of exchanges may form a new security to track the performance of part or all of the securities traded on one or more exchanges of the network of exchanges and/or derivatives thereof. For example such new securities may have features of a mutual fund, index or exchange traded fund. In some embodiments one or more of the exchanges may be issuer-exchanges.

In one embodiment of an exchange system 401 as depicted in FIG. 11a, an exchange system can be provided to an issuer wishing to participate as an issuer-exchange which includes the necessary functions for trading in one or more issuers' securities. For example, an issuer-exchange may own, operate/host and/or maintain an exchange system that allows for trading of not only the issuer-exchange's securities but also for trading securities of other issuers. Other issuer's may elect to have their securities exchanged on such an issuer-exchange based upon any one or more issuer characteristics. For example, issuer characteristics that may provide a basis for one issuer electing to have their securities traded on an issuer-exchange may include market sector/industrial affiliation, corporate affiliation, joint venture agreement, customer base, market capitalization, trading volume, or any other basis upon which an issuer may elect to have its shares traded on an issuer-exchange. Such coupling of issuers and securities may be exchanged over issuer-exchanges where the exchange is owned, operated, directed, controlled, affiliated and/or maintained in whole or in part by the issuer of one or more securities on such an issuer-exchange and/or such couplings could be established by exchanges that are independently owned, operated, directed, controlled, affiliated and/or maintained.

Exchange networks and a network of exchange networks would necessarily require that information be accessible and transferable. Whatever the number or composition of exchanges, any possible communications network 402 can connect the exchange 401 to clients 403 who wish to trade in the issuer's securities. The current invention is not limited to use of an open and/or public network configuration 402, but also may include any number of clients 403 connecting through a closed and/or private network 409 to an exchange system 401. Each exchange system 401 could transfer information about activity with an issuer's security to 0 or n−1 other exchange systems via the network 405 and/or 402. In another embodiment, the exchange system 401 could transfer information related to activity in the issuer's securities via any possible communications network 405 to an arbitrary number (m) of computer systems 406. In addition to the information from the first exchange system 401, any number (n) of exchange systems 401 can transfer information related to activity in an issuer's securities via any possible communications network 405 to an arbitrary number (m) of computer systems 406. The computer systems 406 can transfer data via the communications network 405 to m−1 other computer systems 406 such that all computer systems 406 have substantially similar information from the n exchange systems 401. In another embodiment, the exchange systems 401 can transfer information related to activity in the issuer's securities to some number of computer systems 406 less than m, and the computer systems 406 can transfer their information via any possible communications network 407 to any number of computer systems 408. The computer systems 408 can transfer information to k−1 other computer systems 408 via the communications network 407 such that all computer systems 408 have substantially similar information. In yet another alternative embodiment, the computer systems 408 can transfer their information to another set of computer systems, and that set can transfer its information to yet another set, and so on, until the number of computer systems to which data is transferred ultimately reaches some predetermined number of computer systems, which may be one or many computer systems. In one embodiment, information is transferred though p sets of computer systems 406/408 to a computer system 408, and one single computer system would contain all the information from the n exchange systems 401. Subsets of computer systems 406 and 408 fewer than m and k, respectively, could be created to service different geographical regions or different levels of transaction volume, to facilitate efficient transfer of information and provide assurance of information availability. In some embodiments information may flow from any computer system through any network or combination of networks to any other computer. In other embodiments information may be retained by a particular computer system or set of computer systems connected on one or more networks.

As can be seen in FIGS. 11c, d, the communications network is not limited to the network depicted in FIG. 11a but instead is applicable as well to a wide variety of different communications configurations between the different components of an exchange and between the exchange and the client or clients. In one such embodiment, FIG. 11c, any number of clients 403 can connect to a specific exchange system 401 through a dedicated, private network 402. A dedicated, private network can include for example, a direct T1 connection, direct dial-up, wireless networks, password protected connections, encrypted connections and the like. In the illustrative embodiment depicted in FIG. 11c, the exchange system 401 is not transferring data to any other exchange system.

In addition, as can be seen in the illustrative embodiment depicted in FIG. 11d, any number of clients 403 can connect to any number of exchange systems 401 via a public network or a multiple-use network 404. Public networks can include, for example, the Internet or the like. Multiple use networks can include, for example, frame-relay, or the like, where users share pooled bandwidth with other users to either establish connections to the Internet or to establish connections point-to-point. In the illustrative embodiment depicted in FIG. 11d, the exchange systems 401 are transferring data directly to one another through the network 404, and not necessarily transferring data to other computer systems as in FIG. 11a.

It should also be understood that the networks 402, 405, and 407 could in principle be the same network, or separate networks. In the former case, each system could freely exchange information with any other system. In the latter case, systems not connected to each other by a network would rely on intermediate systems to transfer their information. Additionally, one, some or all of the connections may require authentication and/or encryption. Authentication could take different forms including information known (e.g., a password or the like), possession of an item (e.g., a hardware key, fingerprint, etc.) or the like.

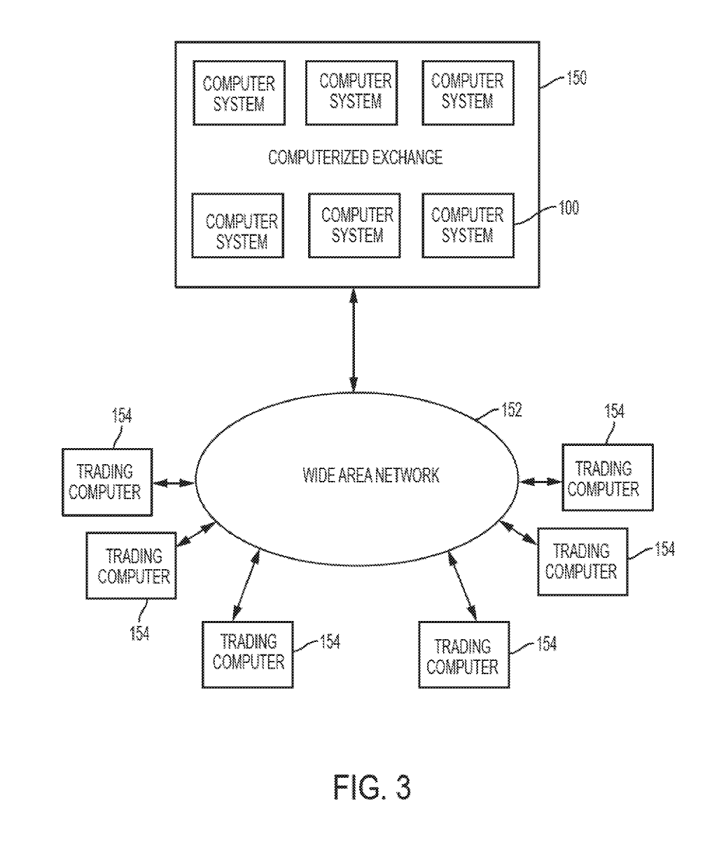

In one embodiment, as shown in FIG. 3, one or more computer systems 100 form a computerized exchange 150 connected to a plurality of user terminals 154 via a communications network 152. The communications network 152 may be formed from a plurality of dedicated connections between the user terminals 154 and the computerized exchange 150, or may take place, in whole or in part, over a public network such as the Internet or one or more virtual private networks (VPN). Communication between the user terminals 154 and the computerized exchange 150 may take place according to any protocol, such as TCP/IP, and may include any desired level of interaction between the user terminals 154 and the computerized exchange 150. To enhance security, especially where communication takes place over a publicly accessible network such as the Internet, communications facilitating or relating to transactions may be encrypted using an encryption algorithm.

As depicted in FIG. 11b, clients can access and execute trades in an issuer's securities in several ways. In one embodiment 500, where the issuer has elected to own, operate and/or maintain its own exchange system, i.e., an issuer-exchange, the client can access 501 the issuer-exchange system 502 in any manner which allows the client to communicate with the issuer-exchange system so that securities can either be bought or sold. For example, a client may: dial-up directly to the issuer-exchange system 502; communicate through a public network, such as the Internet; or communicate through a wireless network system, or the like. In another embodiment 510, where the issuer has elected not to own, operate and/or maintain its own exchange but instead retains the services of a third party to “host” the issuer's exchange, the client can access 501 the hosted exchange system 503 either through a link from the issuer's system 502 to the exchange system, or through a “window” on the issuer's system 502 where the client does not leave the issuer's system 502 but instead is provided with a “framed” window into the hosted exchange system. In this embodiment 510, the exchange system is not provided by the issuer, but the location of the exchange system may appear to the client 501 such that it is indistinguishable from the issuer's system 502. In yet another embodiment 520, the client can access 501 the exchange system 504, which is provided by a third party, by directly accessing the third party's exchange system through any possible communications network. In these embodiments, where the issuer has elected not to own, operate and/or maintain its own exchange, the hosted exchange system, or third party exchange system 504, could either provide for the exchange of securities in only one issuer's securities 520 or could provide for the exchange of one or more issuers' securities 505 on the same hosted exchange system 530. For example, each issuer could have its own hosted exchange system or could elect to be part of a hosted exchange system which provides for the exchange of one or more issuers' securities 505 on the same hosted exchange system 504. In some embodiments there may be a single client and in other embodiments there may be multiple clients. In certain embodiments, either all of the clients could have access to the same information or each client could have different access to different information. For example different information types could be available to different types/classifications of clients where types/classifications of clients may be based on what services they have subscribed to or requested; e.g., free or pay services. In some embodiments predefined/customized information sets may be available to one or more clients. In addition, in some embodiments clients may communicate with other clients sharing some or all of their information. Communications between clients may be hosted by the issuer, one or more exchanges, one or more third parties, or any combination thereof. Communications between any of the issuer, one or more exchanges, one or more third parties, or one or more clients may be wholly or in part available to any of the issuer, one or more exchanges, one or more third parties, or one or more clients. Such information may be available for free or for a fee. Such fees may be due to or from any of the issuer, one or more exchanges, one or more third parties, or one or more clients.

It should be readily understood and fully appreciated by one of ordinary skill in the art that separately hosted exchange systems do not necessarily have to reside on separate computer systems but instead may actually be executed by a single computer system. Additionally, the hosted exchange systems may be executed by a group/network of computers that are configured to distribute processing tasks/activities. In one possible embodiment, such tasks/activities can be apportioned/distributed between or among the systems operated by the issuer and the systems operated by third parties in either an arbitrary manner or a predetermined/predefined manner wherein such variables as network traffic, CPU load, local processes, and the like, are factored into the decision of how to apportion/distribute responsibilities for such tasks/activities. For example, the systems operated by the issuer may be apportioned responsibility for matching buy orders with sell orders whereas the responsibility for clearing, settling, and/or debiting/crediting of accounts may be apportioned to systems not operated by the issuer, or third party systems.

One example of a computerized exchange system, including a description of messages to be sent between a user terminal and a computerized exchange computer, is set forth in U.S. Pat. No. 5,873,071, the content of which is hereby incorporated by reference. The invention is not limited, however, to the particular computerized exchange described in this patent or to the particular message protocol or communication protocol used therein. Rather, the invention applies broadly to any computerized or traditional exchange that may be configured to implement the algorithms and methods of the invention.

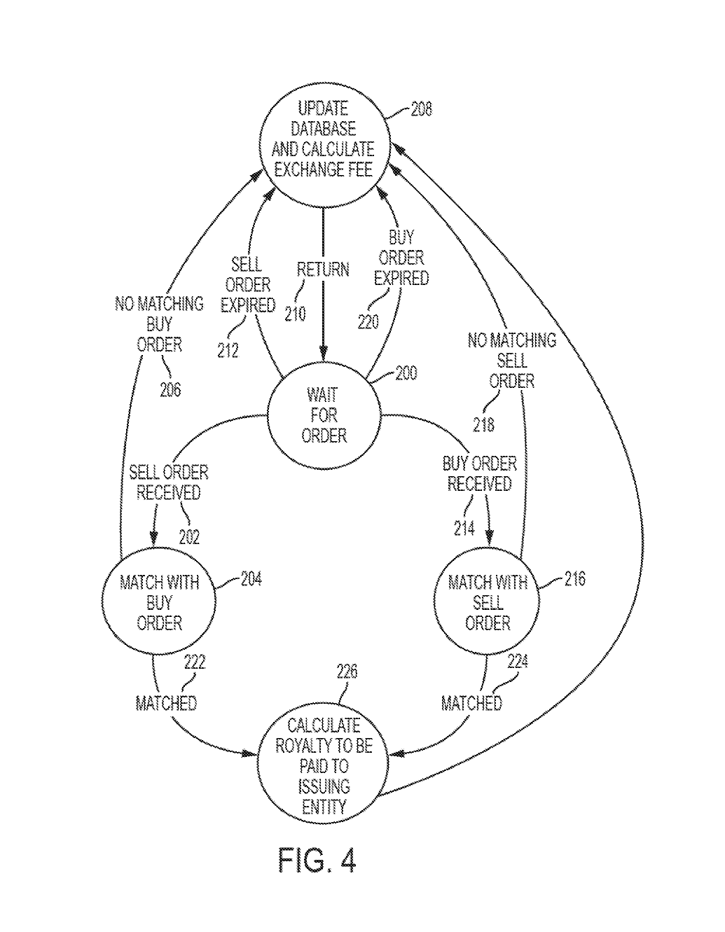

As shown in FIG. 2, the exchange revenue and royalty calculation software 109 contains algorithms and procedures for execution by the CPU 108 that enables the CPU 108 to carry out the methods set forth herein. One such method that may be encoded in software for execution by the CPU 108 is set forth in FIG. 4.

The method and procedures set forth in FIG. 4 may be used to implement, in one illustrative embodiment, a computerized exchange specifically configured to intermediate transactions in a particular type of security, such as stocks, between participants. The computerized exchange in this embodiment may also intermediate transactions in its own securities, such as stock it has issued. Optionally, in this instance, the exchange may elect to forego collection of a royalty on transactions in its own stock, since the exchange is already collecting an exchange fee for its role in the transaction. Alternatively, the method and procedures may be used to implement other embodiments configured to intermediate transactions in other types of securities.

As shown in FIG. 4, the exchange software is configured to match buy and sell orders and to calculate the royalty to be paid to the issuing entity upon completion of a transaction or upon matching of a buy and sell order.

Specifically, the exchange will wait for an order, step 200, until either a buy or sell order is received. The exchange may be configured to be open to conduct transactions 24 hours per day, seven days per week, or for a more limited period of time, such as if the exchange were to keep limited defined trading hours. Likewise, the exchange may be configured to restrict the period of time during which particular securities may be traded, such as to conduct an on-line auction for a particular security or class of securities.

The computerized exchange may be configured to send messages updating participants in transactions at predefined intervals, or upon the occurrence of particular events, such as upon completion of a transaction or at multiple stages during the transaction. The invention is not limited to any particular implementation of a system for notifying participants engaged in transactions.

If a sell order is received, step 202, the exchange attempts to match the sell order with a corresponding buy order, step 204. If there is no matching buy order, step 206, the computerized exchange updates the database, step 208, so that the sell order may be matched with future buy orders, and then returns, step 210, to wait for another order, step 200. If the sell order expires, step 212, before it can be matched with a buy order, the computerized exchange updates the database, step 208, and returns, step 210, to wait for subsequent orders. Each time the database is updated, step 208, or at any other point in this process, the Exchange may calculate a fee to be paid to the Exchange for its roll in the transaction. The Exchange may, as a matter of policy, determine that a fee should be charged at only particular stages during the transaction such as when a transaction is consummated, when a buy or sell order is received, or at any other stage. For convenience, the art of calculating the exchange fee has been included with the act of updating the database, since the database is updated frequently during the process. The invention is not limited in this respect, however.

A similar process occurs when a buy order is received. Specifically, if a buy order is received, step 214, the computerized exchange attempts to match the buy order with a corresponding sell order, step 216. To do this, the computerized exchange will typically poll the database to see if there is any corresponding sell order with parameters indicative of the ability for the respective parties to successfully complete a transaction. The specific criteria used to match buy and sell orders will depend on any number of a variety of factors, such as the type of security involved, the specific rules of the exchange governing the manner in which transactions may proceed, and the protocol used by the exchange in trading securities. The invention is not limited to the criteria or protocol used to match buy and sell orders.

If the computerized exchange is not able to match the buy order with a sell order, step 218, the exchange updates the database, step 208, and returns, step 210, to wait for another order, step 200. Updating the database in this manner enables the computerized exchange to match the buy order with subsequently received sell orders. If the buy order expires, step 220, the computerized exchange updates the database, step 208, and returns to wait for subsequent orders.

The computerized exchange may be configured to process numerous types of orders, such as simple buy or sell orders, as illustrated, or more complicated orders. Examples of more complicated orders include orders with a time duration, orders that are contingent upon the occurrence of another event, etc. Many types of orders are presently used in existing exchanges and the invention is not limited to any particular type of order, any particular protocol used by the exchange to process the order, or to any particular method used by the exchange to execute transactions or match various types of orders.

If the computerized exchange matches a sell order with a buy order, step 222, or matches a buy order with a sell order, step 224, the computerized exchange calculates a royalty to be paid to the issuing entity of the security involved in the transaction, step 226. Thereafter, the database is updated, step 208, to reflect that a transaction has been completed and, optionally, that the buy and sell orders have been filled and the exchange fee is calculated. The computerized exchange then returns, step 210, to wait for another order, step 200.

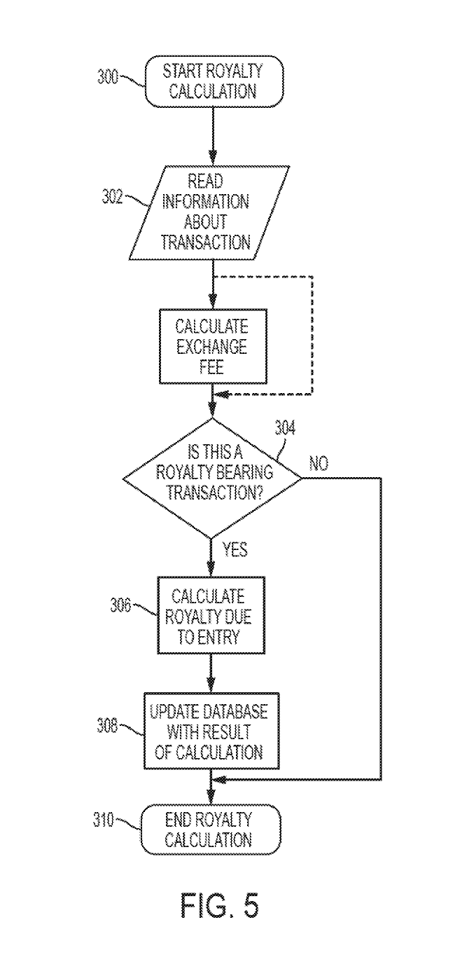

One embodiment of a process for use by the computerized exchange when calculating the royalty owed to the issuing entity is set forth in FIG. 5. As shown in FIG. 5, the computerized exchange starts the royalty calculation, step 300, and reads information about the consummated transaction, step 302. The exchange may then optionally calculate the exchange fee, step 303. Calculation of the exchange fee may take place at any point in this process, or may take place in a separate process. The exchange then determines if this type of transaction is a royalty generating transaction 304, and hence determines if it is necessary to pay a royalty to the issuing entity. If the transaction is not a royalty generating transaction, the computerized exchange ends the royalty calculation process, step 310, or determines that the royalty to be paid is $0.00.

The computerized exchange may take many factors into account when determining whether the transaction qualifies as a royalty generating transaction. For example, the issuing entity of the particular security involved in the transaction may have elected not to receive royalties when its securities are exchanged, or may have elected not to receive royalties for selected transactions, transactions involving a particular participant, or transactions involving a particular type of security. Accordingly, in that instance, the computerized exchange would be programmed not to calculate a royalty for transactions involving those entities securities by reference to, for example, a database which stores information about the entity and the specific instances in which a royalty should or should not be calculated and/or the information associated with, or collected during, the transaction. For example, the computerized exchange may determine from querying the database storing the entity's information that a particular transaction is not a royalty generating transaction if the transaction is smaller than a threshold size. This may be advantageous, for example, where the costs of assessing or collecting a royalty exceed the value of the royalty. Many other factors may also cause the transaction to qualify as a non-royalty generating transaction such as for example: royalties may be calculated only on a portion of the total number of transactions; only on particular types of transactions, such as stock transactions and not option transactions; or for transactions with particular participants. Indeed, the computerized exchange can be programmed to exempt any particular transaction or class of transactions based on any factor or combination of factors identified by the issuing entity, the exchange itself or its rules, intermediaries, or by a governmental regulatory agency.

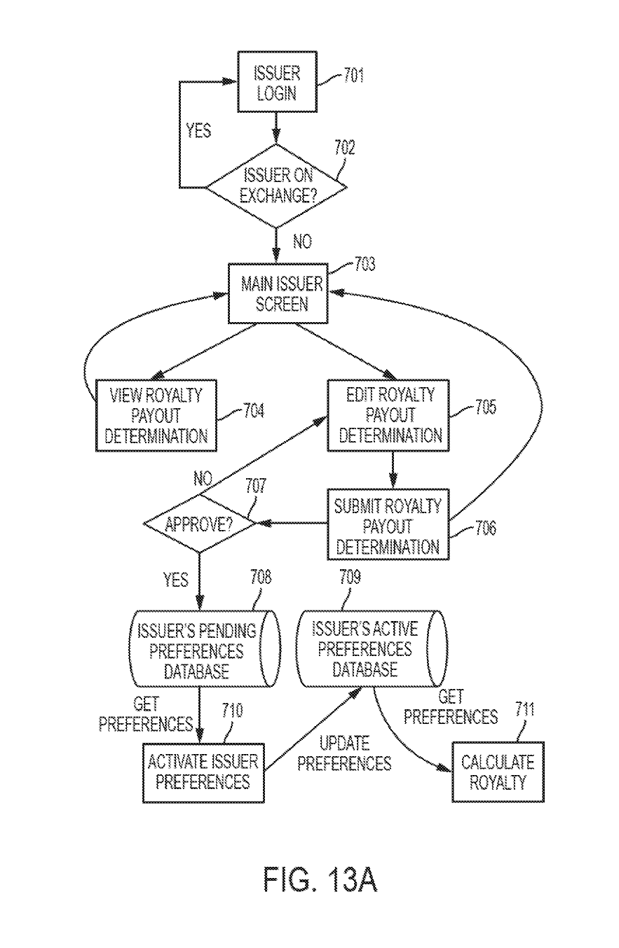

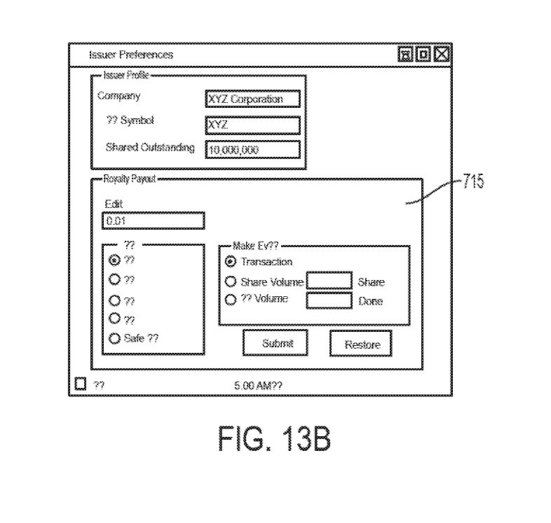

The configuration of the royalty calculation/payment could be performed by the issuer or through an intermediary associated with the exchange. The submission of the initial definition of or update to the configuration of royalty calculation/payment could be performed electronically, non-electronically or both. For example, FIG. 13a illustrates one possible method for electronically submitting an issuer's royalty calculation/payment configuration. An issuer would login into the system at step 701. At step 702 the issuer's login information is checked against a database that stores issuer's identities and login information in order to verify that the issuer is a participant on the exchange. At step 702, if it is determined that the issuer is a participant on the exchange, the issuer is presented with the main issuer screen 703. Main issuer screen 703 allows the issuer to either view the presently configured royalty calculation/payout determination 704 or to be presented with the royalty calculation/payout configuration screen 705 for making changes to the present configuration settings. Any changes that the issuer makes to the royalty calculation/payout configuration settings could then be submitted to the exchange system 706 for approval 707. Approval may be give by the exchange system, a self-regulating organization (SRO), or any other entity, including third-party entities and governmental agencies/bodies. If the exchange system approves of the updated configuration settings at 707, the updated configuration settings would be stored in the issuer's pending preferences database 708. Alternatively, the issuer could be presented with a set of pre-approved royalty/payout configuration settings, for example, in a scrolling window, drop-down box, or the like. At step 710, the pending updates are implemented by placing the updated configuration settings into an active preferences database 709 at an appropriate/predetermined time. At step 711, the presently active royalty calculation/payment configuration is retrieved from the active preferences database 709 and used in the royalty calculation/payment determination.

In one illustrative embodiment, FIG. 13b depicts a representative issuer input form window 715, which may be presented to the issuer at the royalty calculation/payment configuration screen 705. The latter may be presented to an issuer in order to receive from the issuer a specification of its preferences. The issuer could fill out the fields in the issuer input form/window 715, specifying its configuration choices and then transfer the configuration choices so elected to the exchange through, for example, a web site, email, file transfer protocol, wireless, over an automated phone system, or any other means of transferring the information electronically. The exchange could then automatically, or manually, process the request and update the royalty calculation/payment configuration for the issuer to take effect either immediately or at the next appropriate/predetermined time. In one embodiment, the updating of the royalty calculation/payment configuration is accomplished independently of a triggering event or in real-time or close to real-time. Alternatively, in a non-electronic manner, the form could be processed either by a human or automated system associated with the exchange that would update the configuration for the issuer based on their request. The updated configuration settings could then be effected either immediately or at the next appropriate/predetermined time. The rules of the exchange may provide that changes to the royalty calculation/payment configuration can only be effected at certain predefined/predetermined times or only a certain predefined/predetermined number of times, for example, once at the beginning of a fiscal quarter, once a month, only at the end or beginning of each trading day, only four times a month, only 36 times a year, etc. If the exchange does prescribe certain predefined/predetermined times or number of times for making changes to the royalty calculation/payment configuration, then the configuration updates could be queued and instituted at the next appropriate/predetermined time.

An alternative embodiment may allow the issuer to specify within the royalty calculation/payment configuration more than one preference, e.g., a variable royalty calculation/payment configuration. The royalty calculation/payment determination used for a specific transaction or for a given set of circumstances that represent a transaction-unrelated instance could depend upon, for example, any one or more of the following variables: prevailing market conditions, time of day, time of year, prevailing characteristics of the issuer at a given instant in time or even upon optimization of the royalty calculation/payment determination itself. In some embodiments the issuer would specify more than one royalty calculation/payment preference and a relationship between the variables which would be used to determine which royalty calculation/payment algorithm should be applied to a given transaction or to a given set of circumstances that represent a transaction-unrelated instance. The royalty calculation/payment configuration may be presented to the buyer and/or seller of a security. Such presentation may be made electronically, audibly (e.g. telephonically), through physical means (e.g. fax, letter) or other such means. Such presentation may be real time and/or historical.

If the transaction is a royalty generating transaction, the computerized exchange proceeds to calculate the royalty, step 306 and update the database with the result of the calculation, step 308. The computerized exchange then ends the royalty calculation, step 310. As discussed below, the computerized exchange can calculate the royalty owed on the transaction in any manner, including but not limited to: a percentage of the fees received by the exchange; as a portion of a brokers fee received for the transaction; as a portion of the increase in value of the security since it last was purchased or sold by anyone or by the particular participants party to the immediate transaction; as a function of properties associated with each individual participant to the transaction and the then-prevailing market conditions, in general or in particular to the entity; or any other factor that could advantageously be used in calculating the amount adequate to compensate the issuing entity for the transaction.

Optionally, the computerized exchange may automatically debit or credit any specified accounts of the participants in the transaction, whether they be personal accounts, accounts for entities and/or accounts set up specifically for the purpose of trading securities, and may transfer the royalty directly to an entity's account or to an account maintained on behalf of the entity specifically for the purpose of collecting royalties associated with royalty-generating transactions. By authorizing the computerized exchange to transfer funds between accounts, in addition to calculation of the royalty, payment of the royalty to the entity is automatically accomplished without necessitating the intervention of additional third parties. The invention is not limited in this regard, however, as any method of collecting the royalty is encompassed thereby.

Although the computerized exchange has been described in connection with the transaction disclosed in FIG. 1, the computerized exchange may also be adapted for use in facilitating numerous other transactions, and the invention is not limited to a computerized exchange configured to facilitate any one particular transaction. Several other transactions that may be facilitated by the computerized exchange are discussed below. These transactions likewise are not exhaustive, and the invention is not limited to the particular transactions described herein but extends to any transaction that results in economic benefit to the issuing entity or even combinations of such transactions.

Additionally, the current invention may also apply to securities issued by a governmental entity that are taxable by that same entity where a measure of economic benefit or royalty is distributed to the governmental entity that is independent from any tax due or owed to the governmental entity. For example, an exchange of the invention which facilitates the buying and selling of a governmental security issued by a governmental entity which are taxable by that same entity may provide an economic benefit or royalty directly to the governmental entity based on any of the embodiments or mechanisms of the invention. This economic benefit due to the governmental entity may be completely independent or additional to any taxable event created by the trading of the governmental entities securities due or owed to the governmental entity. In another embodiment, the royalty or economic benefit due to the governmental entity may be linked to a taxable event. For example, the royalty may be reduced or increased if a tax was to be levied on a participant in a transaction. A royalty may be due to the governmental entity if no tax were to be levied on a participant in the transaction or no royalty may be due. The royalty or economic benefit may be calculated through mechanisms described in the invention and additionally these mechanisms may include as a variable in the mechanism for determining the royalty or economic benefit due to the governmental entity the amount of tax, the rate of the tax, time, the time the tax is due, the time the taxable event occurred, the type of tax, the type of governmental entity, the type of person or entity from which the tax is due and the like. Additionally, the invention applies to one or more governmental agencies that may at the same time or different times levy a tax on a transaction of a security.

The following transactions can be implemented using any of the computer systems, networks, hardware, software, and/or algorithms described herein, e.g. with reference to FIGS. 2-4, and/or generally known to persons of skill in the art.

### Direct Transactions

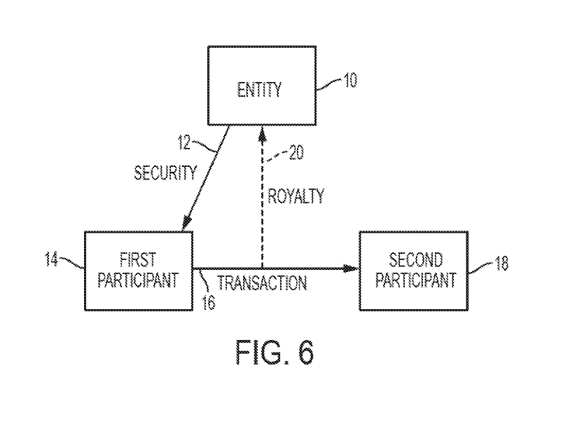

A diagrammatical representation of one illustrative method of compensating the entity for transactions involving securities issued by the entity is set forth in FIG. 6. As shown in FIG. 6, the entity 10 issues a security 12 in a first offering to a first participant 14. The first participant 14 subsequently conducts a transaction 16 involving the security issued by the entity with a second participant 18. A byproduct of that transaction is to transfer a royalty 20 to the entity. Although the illustrated transaction resulting in generation of a royalty in this scenario is the second transaction (the first transaction occurs when the security is first offered to the first participant) the invention is not limited in this respect, and subsequent transactions likewise may be royalty generating transactions. Stated differently, royalty bearing transactions may occur for every transaction n where n>1.

Collection of the royalty by the entity may be accomplished in any number of ways. When stock is issued, for example, the corporation issuing the stock is required to maintain a shareholder list. The corporation may charge a fee to update the stockholder list to list the new owner of the stock. Another way of collecting the royalty would be to contractually obligate, in the bylaws or articles of incorporation, that the purchasing or selling party to the transaction must pay the company a royalty in connection with the transaction. In such instances, it may be advisable and/or necessary for the issuing entity to maintain contractual privity with subsequent holders who take securities in transactions.

### Intermediated Transactions

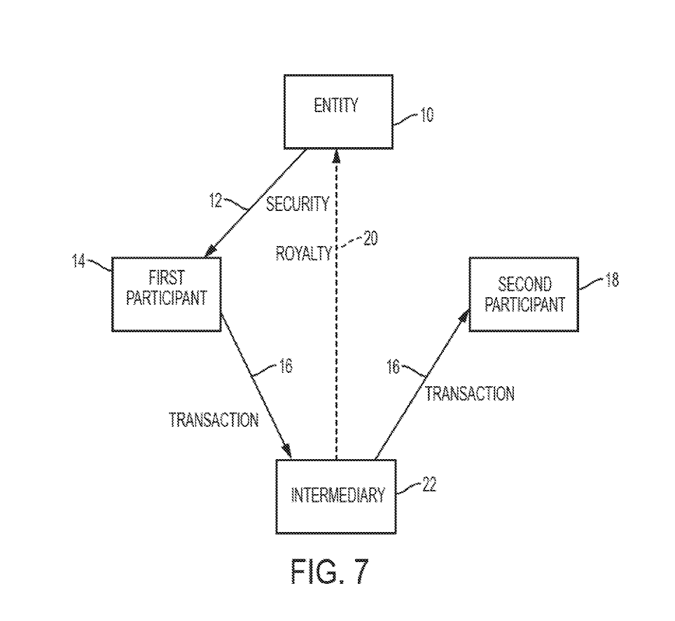

FIG. 7 illustrates a transaction between two participants and at least one intermediary. As shown in FIG. 7, the entity 10 issues a security 12 during a first offering to the first participant 14. As in FIG. 6, the first participant 14 subsequently conducts a transaction 16 involving the security 12 issued by the entity 10 with a second participant 18. In this instance, however, one or more intermediaries 22 facilitate the transaction 16. The intermediary's role may be passive, such as by providing a forum in which transactions may take place, or may be active, such that the intermediary participates in the transaction. For example, the intermediary may be an active intermediary by collecting a sell offer from the first participant 14 and a buy bid from the second participant 18, and matching the offer and bid to enable the participants to consummate the transaction at a mutually agreeable price. The invention is not limited to a particular intermediary, active or passive intermediary, or to any particular protocol used by the intermediary to intermediate transactions. Thus, many more complicated scenarios may be encountered by participants and intermediaries, and the invention is not limited to any one particular type of intermediary or the form of transaction brokered by the intermediaries. The invention is likewise not limited to a single intermediary, as multiple intermediaries may be involved in a particular transaction.

The consummation of the transaction results in a transfer of a royalty 20 to the entity 10. As in FIG. 6, the royalty may be paid by the first participant 14 or the second participant 18 and may be collected using any available method. In this instance, however, the presence of the intermediary 22 may make it more convenient to collect the royalty from the intermediary 22. For example, the intermediary 22 typically will charge for its services associated with facilitating or brokering the transaction 16. Collection from the intermediary 22 in this instance, who is otherwise profiting from the transaction 16, would be straightforward and may be accomplished contractually. For example, an exchange may collect a fee based on a percentage of the value of the transaction 16, a flat fee for its role in facilitating and/or intermediating the transaction 16, or a fee based on the spread between buy and sell prices of the security 12 trading on the exchange. The rules of the exchange, in this embodiment, may obligate the exchange to determine the royalty owed the issuing entity 10, optionally as a percentage or portion of the fee collected by the exchange itself. The rules of the exchange may additionally impose other obligations on the exchange, such as an obligation to pay the determined royalty 20 to the entity 10 or to collect the determined royalty 20 on behalf of the entity 10. Where more than one intermediary is involved in a particular transaction, one or more royalties may be collected from one, a subset, or all of the intermediaries. As with direct transactions royalties may be due for every transaction N where N>1.

As stated previously, it should be understood that the alternative methods and procedures described herein may apply to an issuer/entity acting in any of the capacities of the various parties set forth herein. Therefore, the issuer can take on any one or more of the intermediary roles such as owning, operating and/or maintaining the exchange, acting as a broker for a transaction, acting as a market maker on its own exchange or on any other exchange, acting as a specialist, acting as a counter-party, acting as a clearing/settling agent, and the like. It is envisioned that any role currently performed primarily, or traditionally, by third parties, parties other than the issuer, in transactions involving the exchange of securities can be performed by the issuer. In these instances, the issuer may forego the royalty that would normally be due and owing, may opt to reduce the royalty payment or may opt for any variation/combination thereof.

### Options Transactions

An option is the right either to buy or sell a specified amount or value of a particular underlying interest or security at a fixed exercise price. Most options have an expiration date after which the holders right to exercise the option ceases. An option that gives the holder a right to buy the underlying securities is a call option, and an option which confers a right to sell the underlying securities is called a put option. A person that sells an option is called the option writer, and a person that buys an option is called an option holder.

In the United States, options are backed by the Options Clearing Corporation (“OCC”), which also creates a system for exchanging options through creation of a series of rules governing options transactions. The OCC is designed such that the performance of all options is between the OCC and a group of firms called clearing members that carry the positions of all option holders and option writers in their accounts at the OCC. Under this system, a particular option holder will look to the system created by the OCC's rules, rather than to any particular option writer, for performance of the options. Similarly, option writers must perform their obligations under the OCC system and are not obligated to any particular option holder. The invention is not limited to transactions in options occurring in accordance with the OCC's rules.

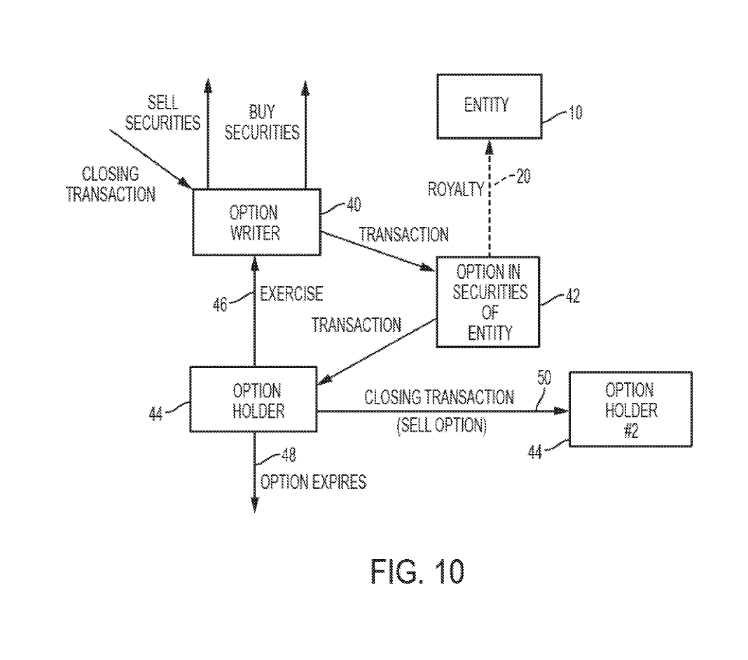

FIG. 10 illustrates several transactions that can take place in a typical options context. The hierarchy imposed by the OCC system on these transactions has not been illustrated to avoid obfuscation.

As shown in FIG. 10, an entity issues securities. Subsequently, an option writer 40 may write an option 42 in securities of the entity. An option holder 44 may then purchase the option 42. Either one, both or some combination of the act of writing and purchasing the option 42 may be a royalty generating transaction for the issuing entity 10. This also is facilitated, as discussed above, by the OCC's rules, since the option writer 40 does not necessarily write the option 42 to the option holder 44. Rather, the act of writing the option 42 and the act of purchasing the option 40 can be distinct transactions that can take place independent 14 of each other.

Subsequently, the option holder 44 may exercise the option 46, may hold the option 42 until it expires 48, or may engage in a closing transaction 50 whereby the option holder 44 cancels out his position in the option 42. A closing transaction 50 by an option holder 44 is an offsetting writing of an identical option 42. Likewise, a closing transaction 50 by an option writer 40 is an offsetting purchase of an identical option 42. Off market transactions, such as gifts of options 42 or sales of options 42, may also occur.

If the option holder 44 decides to exercise the option, step 46, the option holder 44 is either entitled to purchase/sell the specified number of securities at the exercise price, if the option 42 is a physical delivery option; or the option holder 44 is entitled to a specified amount of money, if the option 42 is a cash-settled option.

All of these transactions involving options 42 are fundamentally based on the underlying security. Accordingly, a royalty 20 may be payable to the entity 10 as a result of one or more or possibly even a combination of these transactions associated with options. The specific transaction or combination of transactions that will result in a royalty 20 to the entity is subject to the specific terms of the option 42 involved. For example, the option 42 may be structured such that a percentage of the option contract price is paid to the entity 10 when the option 42 is first issued. Alternatively, the option 42 may be structured such that part of the exercise price is paid to the entity 10 in the form of a royalty 20. A third alternative may be that a royalty 20 on the option 42 may be payable anytime the option holder 44 or option writer 46 engages in a closing transaction 50, any time an option expires 42, or any time the option 42 is exercised. The entity 10 may also be entitled to a royalty 20 anytime an option writer 40 covers his position in the option 42, or when the option writer 40 is forced to purchase or sell securities according to the terms of the option 42. Any event or combination of events involving an option 42 may conceivably be used as a royalty-generating transaction resulting in payment of a royalty 20 to the entity 10. In the case where a combination of events involving an option is the basis for generating a royalty payment, the royalty may become due only in its entirety upon the happening of each of the combination of events so specified or may become due incrementally upon the happening of each event of the combination of events or only on some events. The computerized exchange, discussed above, may be configured to facilitate transactions in options 42 and to calculate royalties 20 for any one or more of these potential royalty generating events.

### Mutual Fund Transactions

In an illustrative embodiment, the invention also applies to distribute economic benefit to issuing entities when shares of a fund, such as a mutual fund, that owns the securities are involved in a transaction. A “fund,” as that term is used herein, includes any holder of one or more securities who sells securities valued or based at least in part on the value of the combination of the held securities. The term fund therefore generally encompasses mutual funds, both open and closed-ended as those terms are generally understood, hedge funds, and other securities generally marketed as deriving their value from a fund as that term is generally understood.

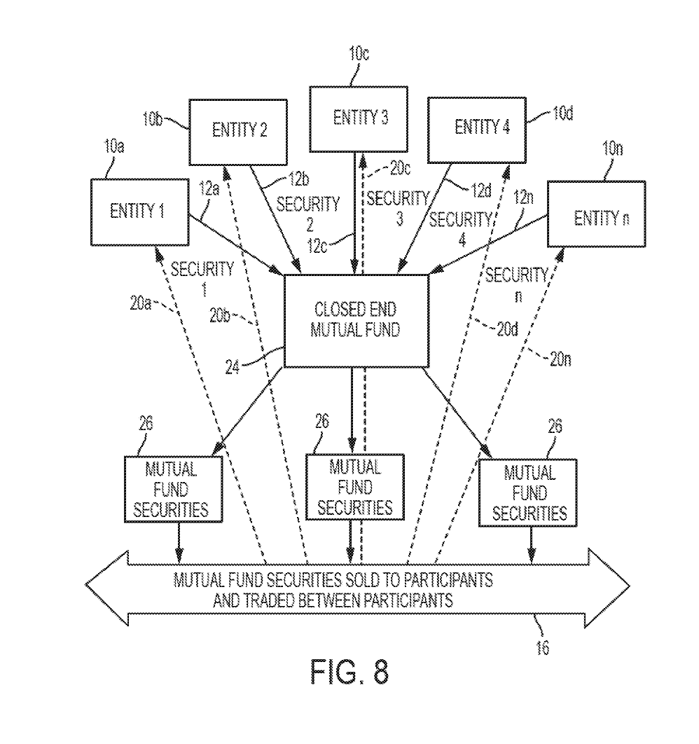

One example of how this may operate in connection with a closed-end mutual fund is illustrated in FIG. 8. For example, as shown in FIG. 8, a typical closed-end mutual fund 24 may own a large number of securities 12a-n issued by multiple entities 10a-n. These securities 12a-n may be acquired in initial offerings or from participants in transactions, such as those described above.

Mutual fund securities 26, typically representing a portion of the total mutual fund 24, are sold to the public at large or to a subsegment of the public in an initial offering. Since the mutual fund is closed-ended, meaning that only a limited number of mutual fund securities 26 are issued, a market for the mutual fund securities 26 may develop independent of the mutual fund 24. Thus, subsequent to the first offering, the mutual fund securities 26 may be involved in transactions just like any other security. However, a transaction involving a mutual fund security 26 may be considered a transaction in a portion of each security 12a-n owned by the mutual fund 24, since the mutual fund's primary assets are the securities 12a-n. Thus, a royalty 20a-n may be payable to the entities 10a-n for transactions involving the mutual fund securities 26. A royalty 20 may also be payable to the entities 10a-n when the mutual fund securities 26 are initially sold, i.e., on the first sale of the mutual fund securities. Likewise, transactions in mutual fund securities 26 may be royalty generating transactions for the mutual fund itself, thus entitling the mutual fund to collect a royalty from the participants and/or intermediaries involved in the mutual fund equity transactions. In this situation, the royalties due to the entities 10a-n and the royalties due to the mutual fund 24 may be separately calculated and separately payable, or may be jointly calculated and paid to the mutual fund 24 for distribution to the entities 10a-n or to a third party for distribution to the entities 10a-n and the mutual fund 24. The invention is not limited to the particular method of calculating and distributing royalties. For simplicity and to avoid obfuscation, only royalties flowing to the entities 10a-n are illustrated in FIG. 8. The royalty is then at least partially distributed to the issuing entities having shares owned by the mutual fund as may be prescribed by the issuing entity particularly for situations where the security is involved in a fund or generally for any transaction involving the entity's security.

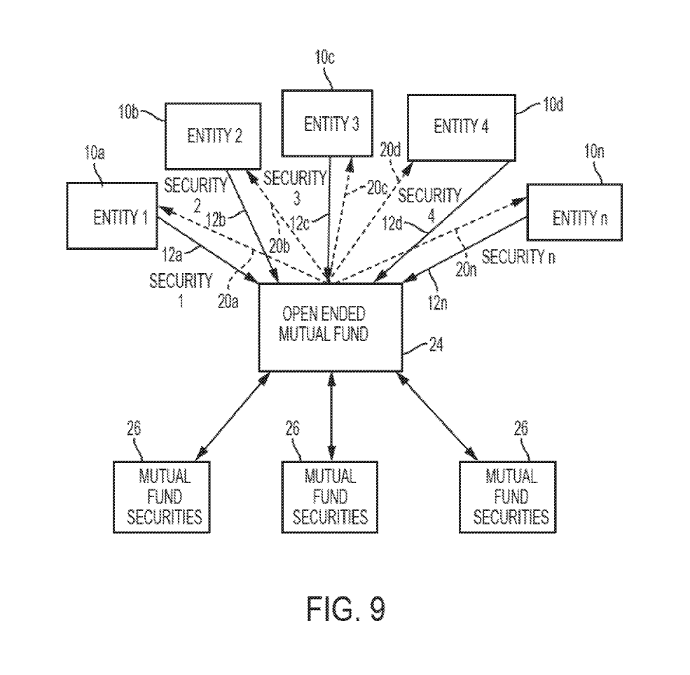

For open-end mutual funds, such as the mutual fund 24 illustrated in FIG. 9, the basic configuration is the same except that the mutual fund 24 is not limited in the number of mutual fund securities 26 it can sell. Accordingly, a secondary market for the mutual fund securities 26 typically will not develop. Instead, the mutual fund securities 26 are purchased from and redeemed to the mutual fund 24 directly. The net asset value of the mutual fund 24 at the end of a calculation period, typically at the end of the day, divided by the number of outstanding mutual fund securities 26, indicates the per share price of each mutual fund security 26.

In this scenario, each time the mutual fund 24 sells a mutual fund security 26, the sale constitutes an initial offering. Accordingly, these sales may not necessarily result in generation of a royalty to the mutual fund 24. However, the sale of 10a-n mutual fund securities is more than likely a second or n^{th} transaction in the underlying securities 12a-n, a transaction on which royalties may be due to the issuing entities.

When a closed-end mutual fund 24 or an open-end mutual fund 24 sells a mutual fund security 26, the sale constitutes a transaction in the securities 12a-n, since the vast majority of the assets of the mutual fund 24 are formed from the securities 12a-n. Accordingly, the entity 10a-n issuing the security 12a-n will be entitled to receive a royalty for that sale. Likewise, when mutual fund securities 26 of a closed-ended mutual fund are traded in the secondary market, or in the relatively rare circumstance where mutual fund equities 26 of an open-ended mutual fund 24 are traded in the secondary market, the transactions involving those equities 26 comprise both a transaction in the mutual fund securities 26, thus potentially entitling the mutual fund 24 to collect a royalty, as well as a transaction in the securities 12a-n forming the assets of the mutual fund 24. Thus, the entities 10a-n potentially will be entitled to receive a royalty on these sales as well.

There are many ways of computing the amount of royalty 20a-n that should be transferred to the entities 10a-n as a result of transactions involving the mutual fund securities 26. For example, the economic benefit to any particular entity 10a-n could be computed as a percentage of the total royalty to be paid. The percentage of the total royalty, in turn, may be based on any rational basis, such as the total value of the securities issued by the entity and owned by the fund divided by the total value of the fund, the total number of securities issued by the entity and owned by the fund divided by the total number of securities owned by the mutual fund, as a percentage of the total increase in value of the fund ascribable to the security as compared to the overall increase in value of the mutual fund, or in any other manner. In the case where the royalty is calculated as a function of the total increase in value of the fund ascribable to the security, such value ascribable to the security may be based on the security's performance on that particular day, over a period of time (absolute value, average value, or the like), or any other measure of value that can be based on the security's performance. As in direct or intermediated transactions between participants, the frequency with which the economic benefit is transferred to the entity may vary depending on these same factors or on any other factors herein described.

The royalty to the entity may be taken as part of the load charged by the mutual fund, may be taken from fees collected by the mutual fund for administering the mutual fund, or may be taken from any other source of income to the mutual fund. Optionally, the royalty due to the entity may be taken as a portion of royalties payable to the mutual fund because of secondary transactions in issued mutual fund securities 26.

A computerized exchange, as discussed above, may be configured to implement transactions in mutual fund securities 26 and to calculate royalty payments 20a-n due to issuing entities 10a-n and the mutual funds 24 themselves when mutual fund securities 26 are involved in transactions.

Another variation on the standard transfer of securities giving rise to generation and transfer of economic benefit to the entity involves the situation where a single brokerage or investment group transfers ownership in the economic entity from one client to another client. In this situation, the transfer of ownership between clients may be treated as a transfer from buyer to seller, discussed above, even though record ownership with the company may not change.

Having thus described at least one illustrative embodiment of the invention, various alterations, modifications and improvements will readily occur to those skilled in the art. Such alterations, modifications, and improvements are intended to be within the spirit and scope of the invention. Accordingly, the foregoing description is by way of example only and is not intended as limiting.

What is claimed is:

1. A computer-implemented exchange system configured to intermediate transactions in corporate securities, the corporate securities each being issued by an issuing entity at an initial offering time, the corporate securities comprising a first corporate security issued by a first issuing entity at a first initial offering time, the exchange system comprising:
at least one computer-readable storage medium having instructions encoded thereon;
at least one computer processor, programmed via the instructions to:
conduct a transaction in the first corporate security at some time other than at the first initial offering time;
determine a measure of financial benefit owed to a second entity, different than the first issuing entity, as a result of conducting the transaction in the first corporate security; and
conduct a transfer of at least a portion of the measure of financial benefit to a third entity, different than the first issuing entity and the second entity, designated by the second entity to receive the at least a portion of the measure of financial benefit.

2. The computer-implemented exchange system of claim 1, wherein the at least one computer processor is programmed via the instructions to conduct transactions in corporate securities selected from a group consisting of stocks, bonds, notes, and debentures.

3. The computer-implemented exchange system of claim 1, wherein the corporate securities comprise a second corporate security issued by the second entity.

4. The computer-implemented exchange system of claim 1, wherein the corporate securities comprise a third corporate security issued by the third entity.

5. The computer-implemented exchange system of claim 1, comprising one or more of a standalone exchange, an exchange network and a network of exchange networks.

6. The computer-implemented exchange system of claim 5, wherein the computer-implemented exchange system comprises an exchange network or a network of exchange networks, and wherein the exchange network or the network of exchange networks is formed based at least in part on one or more characteristics of issuers of the corporate securities.

7. The computer-implemented exchange system of claim 6, wherein at least one exchange in the exchange network or a network of exchange networks is an issuer-exchange.

8. The computer-implemented exchange system of claim 7, wherein the issuer-exchange is configured to intermediate transactions in corporate securities issued by entities other than the issuer-exchange.
